(19) United States
(12) Patent Application Publication
(10) Pub. No.: US 2022/0411055 A1
(43) Pub. Date: Dec. 29, 2022

(54) UNMANNED AERIAL VEHICLE AND CONTROL METHOD OF THE SAME

(71) Applicant: Toyo Seikan Co., Ltd., Tokyo (JP)

(72) Inventors: Atsushi KOMINAMI, Kanagawa (JP); Souji ARAKI, Kanagawa (JP)

(21) Appl. No.: 17/787,590

(22) PCT Filed: Nov. 6, 2020
(86) PCT No.: PCT/JP2020/041628

§ 371 Date: Jun. 21, 2022

(30) Foreign Application Priority Data
Dec. 23, 2019 (JP) 2019-232051
Mar. 16, 2020 (JP) 2020-045726

(51) Int. Cl. B64C 39/02; B05B 13/00; B05B 15/72; B05B 12/12; B64D 1/16

(52) U.S. Cl. CPC B64C 39/024; B05B 13/005; B05B 15/72; B05B 12/122; B64D 1/16

(57) ABSTRACT

Provided is an unmanned aerial vehicle including: a discharge port configured to discharge contents in a container; an expansion/contraction unit configured to connect the discharge port and the container and be expandable; and a discharge position control unit configured to control expansion/contraction of the expansion/contraction unit.

### BACKGROUND

### 1. Technical Field

The present invention relates to an unmanned aerial vehicle and a control method thereof.

### 2. Related Art

An unmanned aerial vehicle including a fluid injection nozzle is conventionally known. (see, for example, Patent Document 1).

### CITATION LIST

### Patent Document

Patent Document 1: Japanese Patent Application Publication No. 2019-18589

### GENERAL DISCLOSURE

A first aspect of the present invention provides an unmanned aerial vehicle including: a discharge port configured to discharge contents in a container; an expansion/contraction unit configured to connect the discharge port and the container and be expandable; and a discharge position control unit configured to control expansion/contraction of the expansion/contraction unit.

The unmanned aerial vehicle may include: an acquisition unit configured to acquire flight information and control information of the unmanned aerial vehicle. The discharge position control unit may control the expansion/contraction on the basis of an acquisition result of the acquisition unit.

The acquisition unit may include an attitude detection unit for detecting an attitude during flight.

The acquisition unit may include a shape detection unit configured to detect a shape of a discharge target to which the contents are discharged.

The unmanned aerial vehicle may include: a distance measuring sensor provided side by side with the discharge port and configured to measure a distance to the discharge target. The acquisition unit may acquire a measurement result from the distance measuring sensor.

The unmanned aerial vehicle may include: a rotation mechanism configured to be capable of controlling an angle of the discharge port with respect to the discharge target to which the contents are discharged. The discharge position control unit may control the angle of the discharge port by operating the rotation mechanism on the basis of the acquisition result.

The unmanned aerial vehicle may include: a rotary connection portion configured to connect the expansion/contraction unit to a main body of the unmanned aerial vehicle. The rotation mechanism may control the angle of the expansion/contraction unit by rotationally driving the rotary connection portion.

The unmanned aerial vehicle may include: an attitude detection unit for detecting an attitude during flight. The discharge position control unit may control the expansion/contraction on the basis of a detection result of the attitude detection unit.

The expansion/contraction unit may include a first extending portion, a second extending portion provided on a distal end side of the expansion/contraction unit with respect to the first extending portion, and a bent portion configured to bendably connect the first extending portion and the second extending portion.

The expansion/contraction unit may include a balloon structure portion configured to be inflated when an internal pressure increases and expand when the balloon structure portion is inflated.

The expansion/contraction unit may include a piston cylinder configured to expand/contract due to variation in the internal pressure. The piston cylinder may include a housing, a rod portion provided to at least partially protrude from the housing, and a drive portion provided at an end of the rod portion inside the housing, the drive portion configured to move due to an air pressure difference inside the housing to vary a length of the rod portion protruding from the housing.

The expansion/contraction unit may include an elastic body and contracts due to a restoring force of the elastic body.

The unmanned aerial vehicle may include a winding unit provided side by side with the expansion/contraction unit. The winding unit may wind the expansion/contraction unit by a rotational operation to contract the expansion/contraction unit.

The unmanned aerial vehicle may include: a pressure source configured to vary an internal pressure of the expansion/contraction unit. The expansion/contraction unit may expand/contract due to an internal pressure variation.

The pressure source may vary an internal air pressure of the expansion/contraction unit.

The pressure source may be an aerosol container.

The contents may be at least one of a liquid, a sol, or a gel.

A second aspect of the present invention provides a control method of an unmanned aerial vehicle. The control method of the unmanned aerial vehicle includes: guiding the unmanned aerial vehicle to a vicinity of a discharge target to which contents filled in a container of the unmanned aerial vehicle are discharged; controlling expansion/contraction of an expansion/contraction unit provided to be expandable/contractible between a discharge port for discharging the contents and the container; and discharging the contents to the discharge target.

The control method of the unmanned aerial vehicle may include: controlling an angle of the discharge port with respect to the discharge target before the discharging the contents to the discharge target.

The control method of the unmanned aerial vehicle may include: moving the unmanned aerial vehicle with respect to the discharge target in a predetermined direction; and controlling the expansion/contraction of the expansion/contraction unit according to an outer shape of the discharge target while moving the unmanned aerial vehicle.

The control method of the unmanned aerial vehicle may include: detecting an outer shape of the discharge target and a distance to the discharge target after the guiding and before the controlling the expansion/contraction.

The control method of the unmanned aerial vehicle may include: adjusting a position and an angle of the unmanned aerial vehicle with respect to the discharge target on the basis of a result of detection of the discharge target.

The summary clause does not necessarily describe all necessary features of the embodiments of the present invention. The present invention may also be a sub-combination of the features described above.

### BRIEF DESCRIPTION OF THE DRAWINGS

FIG. 1A illustrates an example of a side view of an unmanned aerial vehicle 100 in which an expansion/contraction unit 40 is in a contracted state.

FIG. 1B illustrates an example of a side view of the unmanned aerial vehicle 100 in which the expansion/contraction unit 40 is in an expanded state.

FIG. 1C illustrates an example of a side view of the unmanned aerial vehicle 100 including a distance measuring sensor 77.

FIG. 1D illustrates an example of the side view of the unmanned aerial vehicle 100 including the distance measuring sensor 77.

FIG. 2 illustrates an outline of a block diagram regarding a function of a discharge position control unit 16.

FIG. 3A illustrates an example of an expansion/contraction mechanism 45 in the contracted state.

FIG. 3B illustrates an example of the expansion/contraction mechanism 45 in the expanded state.

FIG. 4A illustrates another example of the expansion/contraction mechanism 45 in a contraction transient state.

FIG. 4B illustrates another example of the expansion/contraction mechanism 45 in an expansion transient state.

FIG. 5A illustrates an example of a side view of the unmanned aerial vehicle 100 in the contracted state in which the expansion/contraction mechanism 45 is operated with a pressure supplied from a container 70.

FIG. 5B illustrates an example of a side view of the unmanned aerial vehicle 100 in the expansion transient state in which the expansion/contraction mechanism 45 is operated with the pressure supplied from the container 70.

FIG. 5C illustrates an example of a side view of the unmanned aerial vehicle 100 in the expanded state in which the expansion/contraction mechanism 45 is operated with the pressure supplied from the container 70.

FIG. 6A illustrates another example of a side view of the unmanned aerial vehicle 100 in the contracted state in which the expansion/contraction mechanism 45 is operated with the pressure supplied from the container 70.

FIG. 6B illustrates another example of a side view of the unmanned aerial vehicle 100 in the expanded state in which the expansion/contraction mechanism 45 is operated with the pressure supplied from the container 70.

FIG. 7 illustrates an example of a cross-sectional perspective view of the expansion/contraction unit 40.

FIG. 8A illustrates an example of a winding unit 250 in a state where the expansion/contraction unit 40 is in the contracted state.

FIG. 8B illustrates an example of the winding unit 250 in a state where the expansion/contraction unit 40 is in the expansion transient state.

FIG. 8C illustrates an example of the winding unit 250 in a state where the expansion/contraction unit 40 is in the expanded state.

FIG. 9A illustrates an example of a front view of the expansion/contraction unit 40.

FIG. 9B illustrates an example of a schematic cross-sectional view of an upper surface of the expansion/contraction unit 40.

FIG. 10A illustrates an example of a side view of the unmanned aerial vehicle 100 having the winding unit 250 in a state where the expansion/contraction unit 40 is in the contracted state.

FIG. 10B illustrates an example of a side view of the unmanned aerial vehicle 100 having the winding unit 250 in a state where the expansion/contraction unit 40 is in the expansion transient state.

FIG. 10C illustrates an example of a side view of the unmanned aerial vehicle 100 having the winding unit 250 in a state where the expansion/contraction unit 40 is in the expanded state.

FIG. 10D illustrates an example of a side view of the unmanned aerial vehicle 100 having the winding unit 250 in a discharge preparation completed state of a tube portion 65.

FIG. 11A illustrates another example of a side view of the unmanned aerial vehicle 100 having the winding unit 250 in a state where the expansion/contraction unit 40 is in the contracted state.

FIG. 11B illustrates another example of a side view of the unmanned aerial vehicle 100 having the winding unit 250 in a state where the expansion/contraction unit 40 is in the expansion transient state.

FIG. 11C illustrates another example of a side view of the unmanned aerial vehicle 100 having the winding unit 250 in a state where the expansion/contraction unit 40 is in the expanded state.

FIG. 11D illustrates another example of a side view of the unmanned aerial vehicle 100 having the winding unit 250 in the discharge preparation completed state of the tube portion 65.

FIG. 12 illustrates an example of a side view illustrating a sensing range 78 of the distance measuring sensor 77.

FIG. 13A illustrates an example of a side view when the unmanned aerial vehicle 100 is controlled to translate with respect to a discharge target 300 having an unevenness.

FIG. 13B illustrates an example of a side view when the unmanned aerial vehicle 100 is controlled to translate with respect to the discharge target 300 having the unevenness.

FIG. 14A illustrates an example of a top view when the unmanned aerial vehicle 100 is controlled to translate with respect to the discharge target 300 having an unevenness.

FIG. 14B illustrates an example of a top view when the unmanned aerial vehicle 100 is controlled to translate with respect to the discharge target 300 having the unevenness.

FIG. 15 illustrates an example of an enlarged view of the vicinity of the container 70 and a support portion 30.

FIG. 16A illustrates an example of a top view when the expansion/contraction unit 40 is controlled to rotate with respect to the discharge target 300 having a curved surface shape.

FIG. 16B illustrates an example of a top view when the expansion/contraction unit 40 is controlled to rotate with respect to the discharge target 300 having the curved surface shape.

FIG. 17A illustrates an example of a side view when the expansion/contraction unit 40 is controlled to rotate with respect to the discharge target 300 having an unevenness.

FIG. 17B illustrates an example of a side view when the expansion/contraction unit 40 is controlled to rotate with respect to the discharge target 300 having the unevenness.

FIG. 17C illustrates an example of a side view when the expansion/contraction unit 40 is controlled to rotate with respect to the discharge target 300 having the unevenness.

FIG. 17D illustrates an example of a side view when the expansion/contraction unit 40 is controlled to rotate with respect to the discharge target 300 having the unevenness.

FIG. 18A illustrates an example of a side view of the unmanned aerial vehicle 100 having the expansion/contraction unit 40 which expands/contracts in two stages in a state where the expansion/contraction unit 40 is in the contracted state.

FIG. 18B illustrates an example of a side view of the unmanned aerial vehicle 100 having the expansion/contraction unit 40 which expands/contracts in two stages in a state where a first extending portion 66 expands.

FIG. 18C illustrates an example of a side view of the unmanned aerial vehicle 100 having the expansion/contraction unit 40 which expands/contracts in two stages in a state where a second extending portion 68 expands.

FIG. 18D illustrates an example of a side view of the unmanned aerial vehicle 100 having the expansion/contraction unit 40 which expands/contracts in two stages in a state where the expansion/contraction unit 40 is rotated.

FIG. 19 illustrates an example of the expansion/contraction unit 40 which expands/contracts in two stages.

FIG. 20A illustrates an example of the expansion/contraction unit 40 which expands/contracts in two stages in a state where the expansion/contraction unit 40 is in a contraction transient state.

FIG. 20B illustrates an example of the expansion/contraction unit 40 which expands/contracts in two stages in a contraction transient state in which the first extending portion 66 expands.

FIG. 20C illustrates an example of the expansion/contraction unit 40 which expands/contracts in two stages in a state where the expansion/contraction unit 40 is in a contracted state.

FIG. 21 illustrates an example of a flow diagram of a control method 400 of the unmanned aerial vehicle 100.

FIG. 22 illustrates another example of a flow diagram of the control method 400 of the unmanned aerial vehicle 100.

### DESCRIPTION OF EXEMPLARY EMBODIMENTS

Hereinafter, (some) embodiment(s) of the present invention will be described. The embodiment(s) do(es) not limit the invention according to the claims, all the combinations of the features described in the embodiment(s) are not necessarily essential to means provided by aspects of the invention.

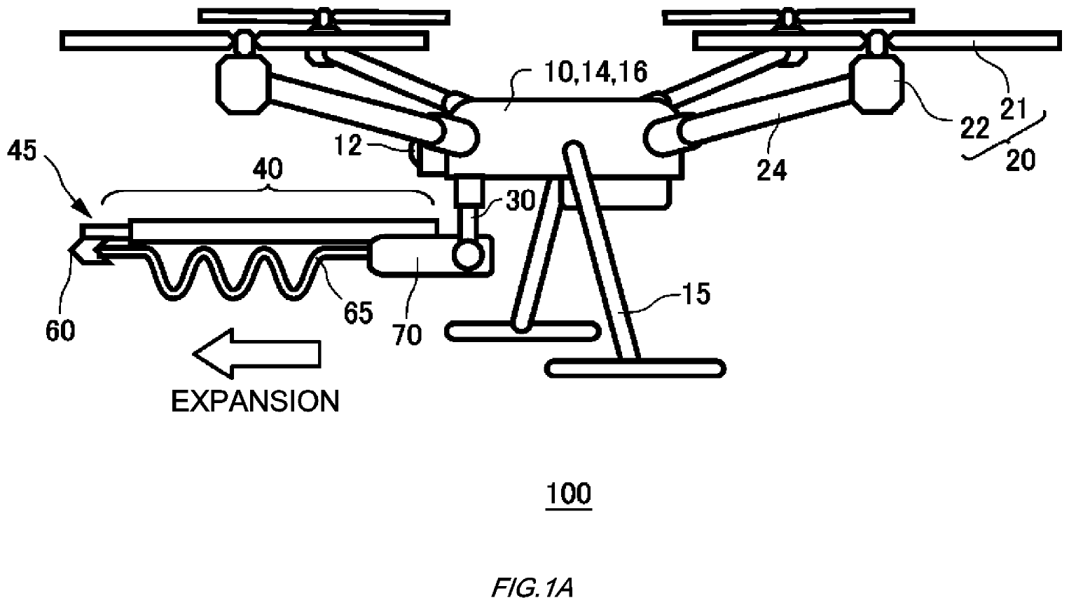

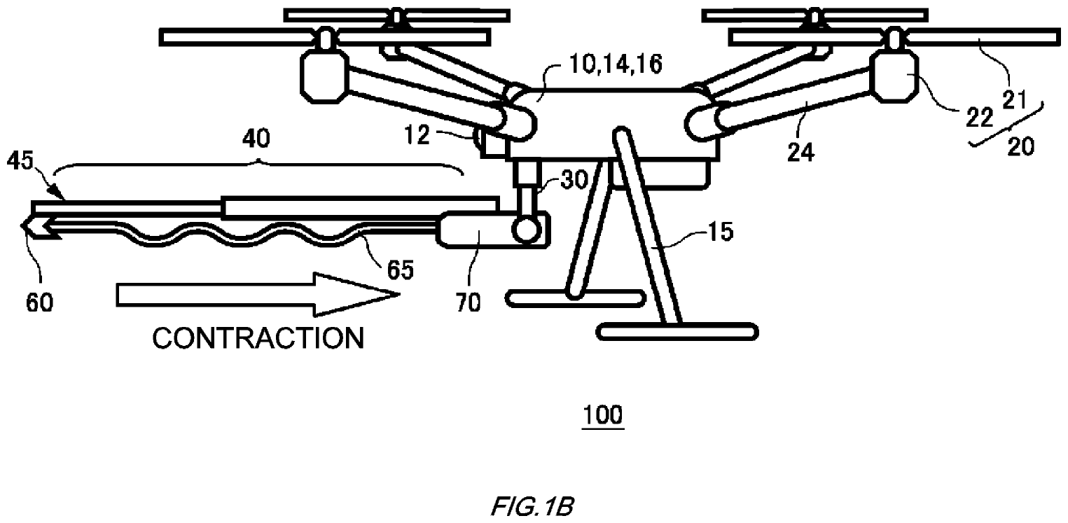

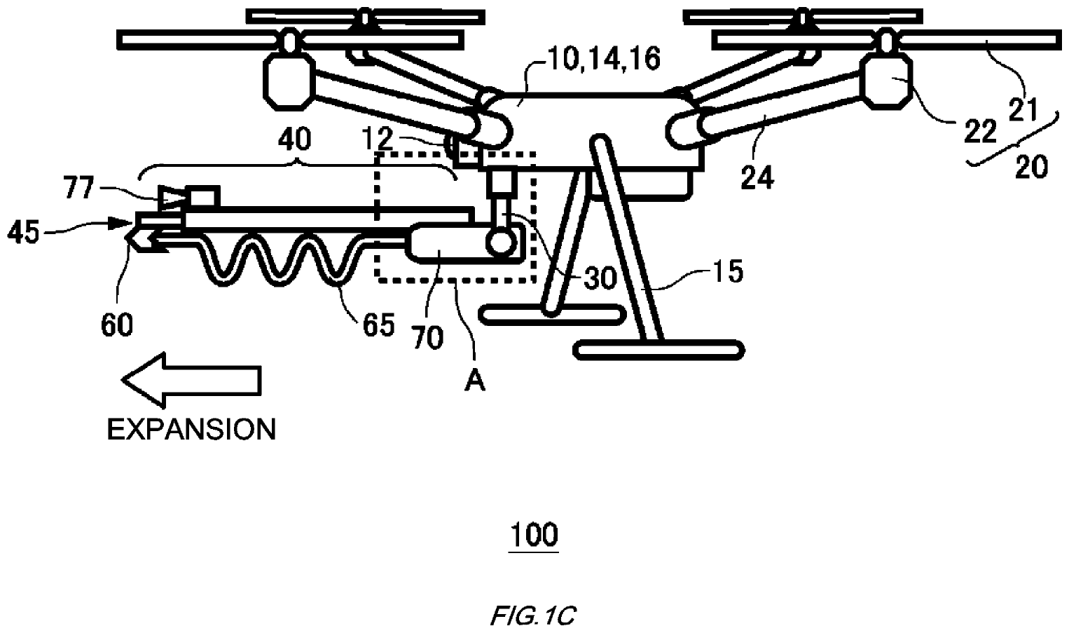

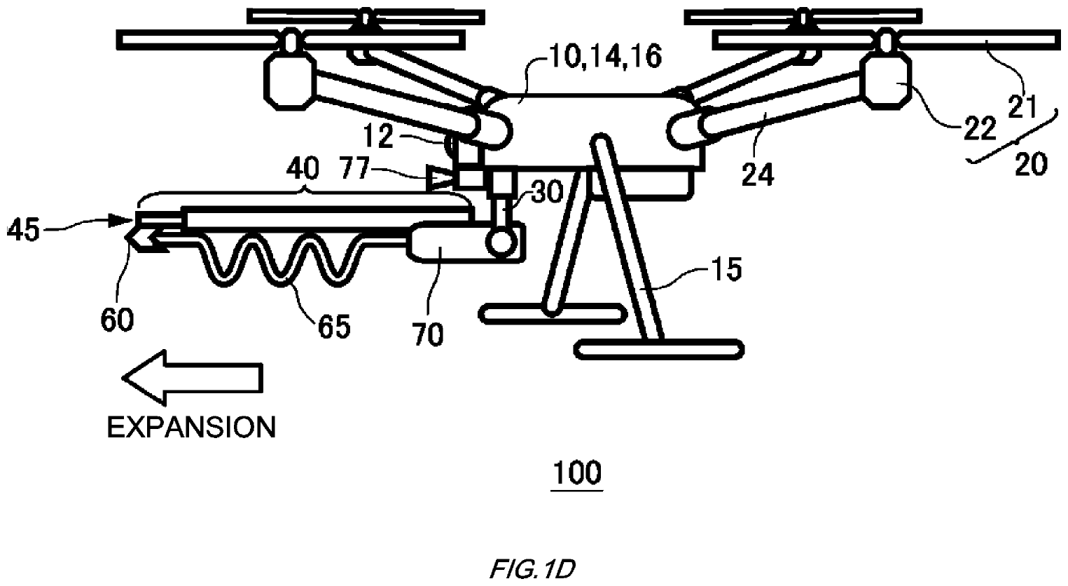

FIG. 1A illustrates an example of a side view of the unmanned aerial vehicle 100 in which an expansion/contraction unit 40 is in a contracted state. The unmanned aerial vehicle 100 of the present example includes a main body 10, an imaging device 12, an acquisition unit 14 included in the main body 10, a leg portion 15, a propulsion unit 20, an arm portion 24, a support portion 30, the expansion/contraction unit 40, a discharge port 60, and a container 70.

The unmanned aerial vehicle 100 is a flying body that flies in the air. The unmanned aerial vehicle 100 discharges the contents stored in the container 70 from the discharge port 60.

The main body 10 stores various control circuits, a power supply, and the like of the unmanned aerial vehicle 100. In addition, the main body 10 may function as a structure body that couples the configurations of the unmanned aerial vehicle 100. The main body 10 in the present example is coupled to the propulsion unit 20 by the arm portion 24. The main body 10 of the present example includes the imaging device 12 which images the surroundings of the unmanned aerial vehicle 100, and includes an acquisition unit 14 connected to the imaging device 12 inside the main body 10.

The propulsion unit 20 generates a propulsion force for propelling the unmanned aerial vehicle 100. The propulsion unit 20 includes rotary blades 21 and a rotary drive device 22. The unmanned aerial vehicle 100 of the present example includes four propulsion units 20. The propulsion unit 20 is attached to the main body 10 via the arm portion 24. Note that the unmanned aerial vehicle 100 may be a flying body including a fixed blade as the propulsion unit 20.

The rotary blade 21 generates a propulsion force by rotation. Four rotary blades 21 are provided about the main body 10, but the arrangement method of the rotary blades 21 is not limited to the present example. The rotary blade 21 is provided at the distal end of the arm portion 24 via the rotary drive device 22.

The rotary drive device 22 includes a power source such as a motor and drives the rotary blade 21. The rotary drive device 22 may have a brake mechanism of the rotary blade 21. As an example, the control of the rotary drive device 22 is performed by a control circuit provided in the main body 10. However, the control device of the rotary drive device 22 may be incorporated in the rotary drive device 22 or may be provided side by side. The rotary blade 21 and the rotary drive device 22 may be directly attached to the main body 10 without the arm portion 24.

As an example, the arm portions 24 are provided radially extending from the main body 10. The unmanned aerial vehicle 100 of the present example includes four arm portions 24 provided to correspond to the four propulsion units 20, respectively. However, the number of propulsion units 20 and arm portions 24 is not limited to four as long as a sufficient number for maintaining the attitude of the unmanned aerial vehicle 100 during flight is provided. As an example, when four arm portions 24 are provided, the arms may be provided at positions having four-fold rotational symmetry about the main body 10. However, it is sufficient if the extending direction of the arm portion 24 is any direction suitable for holding the attitude of the unmanned aerial vehicle 100, and according to the centroid position of the unmanned aerial vehicle 100, the arm portion may extend in a direction different from the rotationally symmetric direction. The arm portion 24 may be fixed or movable.

The leg portion 15 is a leg which is coupled to the main body 10 and holds the attitude of the unmanned aerial vehicle 100 at the time of landing, landing on water, or the like. The leg portion 15 holds the attitude of the unmanned aerial vehicle 100 in a state where the propulsion unit 20 is stopped. The unmanned aerial vehicle 100 of the present example has two leg portions 15, but the number and structure of the legs are not limited thereto.

The support portion 30 supports the expansion/contraction unit 40 and the container 70. The support portion 30 may be provided by a member having rigidity such as metal or hard resin. The support portion 30 may have a mechanism for tilting a direction of supporting the expansion/contraction unit 40 or the container 70, and may have a bending element for changing an angle.

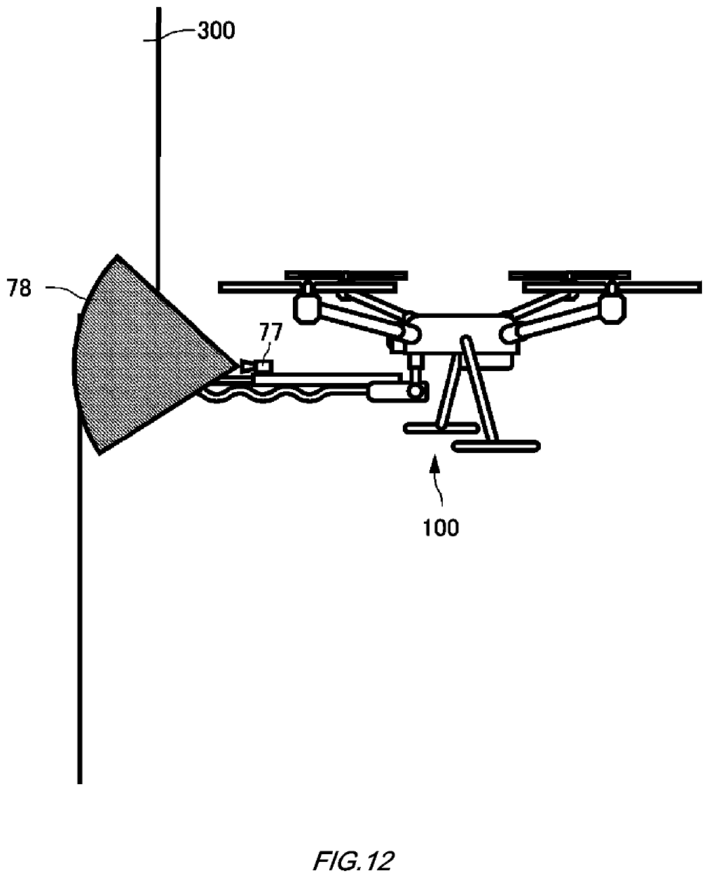

The expansion/contraction unit 40 includes an expansion/contraction mechanism 45, a discharge port 60 for discharging the contents in the container, and a tube portion 65 for connecting the discharge port 60 and the container 70. The length of the expansion/contraction unit 40 can be varied by the operation of the expansion/contraction mechanism 45. Even in a location where other members of the unmanned aerial vehicle 100 such as the rotary blade 21 hardly enter, by expanding the expansion/contraction unit 40, particularly, a discharge target 300 described below in FIG. 12 can be accurately targeted, and the contents can be discharged from the discharge port 60.

The expansion/contraction mechanism 45 may be a mechanism that operates by a pressure, or may be a mechanism that mechanically operates with a motor or the like. The expansion/contraction mechanism 45 of the present example is provided separately from the tube portion 65 in parallel with the tube portion 65. In another example, the tube portion 65 is provided to have a balloon structure such as a membrane-like member having an elasticity, and the tube portion 65 itself expands/contracts by allowing a fluid to flow into and out from the balloon structure. Such an example corresponds to an example in which the tube portion 65 itself has the expansion/contraction mechanism 45.

The discharge port 60 is provided at an end of the tube portion 65 on the side opposite to the container 70 side. The discharge port 60 discharges the contents in the container 70 to the discharge target 300. As an example, the discharge port 60 includes a nozzle for adjusting a flow rate, a flow velocity, a pressure, and the like of the contents to be discharged.

The tube portion 65 is in fluid communication with the discharge port 60 and the container 70. As an example, the tube portion 65 is a hose in which a reinforcing material is taken into a flexible elastic body, but may be a tube including only an elastic body. As an example, the cross section of the tube portion 65 has a circular shape, but may have a polygonal shape. Through the tube portion 65, the contents are injected from the container 70 into the discharge port 60.

The imaging device 12 captures a video of surroundings of the unmanned aerial vehicle 100. As an example, the imaging device 12 is a CMOS camera, a CCD camera, or the like. However, the imaging device 12 only needs to be able to capture a video of surroundings, and may be another imaging device. The video captured by the imaging device 12 is not limited to a video of visible light (an electromagnetic wave having a wavelength of about 360 nm to about 830 nm), and the imaging device 12 may be an infrared camera or the like that captures a video by an electromagnetic wave (for example, an infrared region of about 830 nm to about 15 μm) of a longer wavelength region. In the present example, one imaging device 12 is provided, but a plurality of imaging devices 12 may be provided according to the type of video to be captured, the imaging range, and the like. In addition, in the present example, the imaging device 12 is provided in the main body 10, but the imaging device 12 may be provided at a different position of the unmanned aerial vehicle 100.

The acquisition unit 14 acquires flight information and control information of the unmanned aerial vehicle 100. The acquisition unit 14 of the present example is provided in the main body 10, but may be provided at a different position. The acquisition unit 14 of the present example is electrically connected to the imaging device 12 and receives video data or image data from the imaging device 12. However, the acquisition unit 14 may be provided integrally with the imaging device 12, or may be communicably connected to the imaging device 12. The acquisition unit 14 of the present example analyzes the imaging result of the imaging device 12, and acquires the flight information of the unmanned aerial vehicle 100, the control information of the discharge position control unit 16, and the like.

The discharge position control unit 16 controls the expansion/contraction state of the expansion/contraction unit 40. The discharge position control unit 16 of the present example is provided in the main body 10, but may be provided at a different position. The discharge position control unit 16 of the present example is electrically connected to the acquisition unit 14 and receives the acquisition result from the acquisition unit 14. However, the discharge position control unit 16 may be communicably connected to the acquisition unit 14. The discharge position control unit 16 can control the expansion/contraction or the angle of the expansion/contraction unit 40 on the basis of the detection result of the acquisition unit 14.

The container 70 is a container for filling contents. In an example, the container 70 is an aerosol container for discharging the contents filled in the container. In another example, the contents are at least one of a liquid, a sol, or a gel. The aerosol container ejects the contents by the gas pressure of the liquefied gas or the compressed gas filled in the container. The container 70 of the present example is a metal aerosol can, but may be a plastic container having a pressure resistance.

FIG. 1B illustrates an example of a side view of the unmanned aerial vehicle 100 in which the expansion/contraction unit 40 is in an expanded state. A difference from FIG. 1A will be mainly described below. In the present example, by the operation of the expansion/contraction mechanism 45, the tube portion 65 is stretched from a bent state, and the expansion is made such that the length of the expansion/contraction unit 40 is also longer than the length of the expansion/contraction unit 40 in FIG. 1A.

When the expansion/contraction unit 40 is in the expanded state, the expansion/contraction mechanism 45 can operate to contract the expansion/contraction unit 40 in length. As a result, the moment of inertia of the unmanned aerial vehicle 100 decreases. Therefore, even when the unmanned aerial vehicle 100 flies at a high speed, a rotational torque caused by an inertial force received from a vibration is reduced, and the flight attitude is stabilized.

When the expansion/contraction unit 40 is in the contracted state, a risk that the expansion/contraction unit 40 collides with a surrounding object is reduced even when the unmanned aerial vehicle 100 enters a narrow space during the flight of the unmanned aerial vehicle 100. As a result, the flight control of the unmanned aerial vehicle 100 is facilitated.

FIG. 1C illustrates an example of a side view of the unmanned aerial vehicle 100 with a distance measuring sensor 77. In the present example, particularly, a difference from unmanned aerial vehicle 100 in FIGS. 1A and 1B will be mainly described.

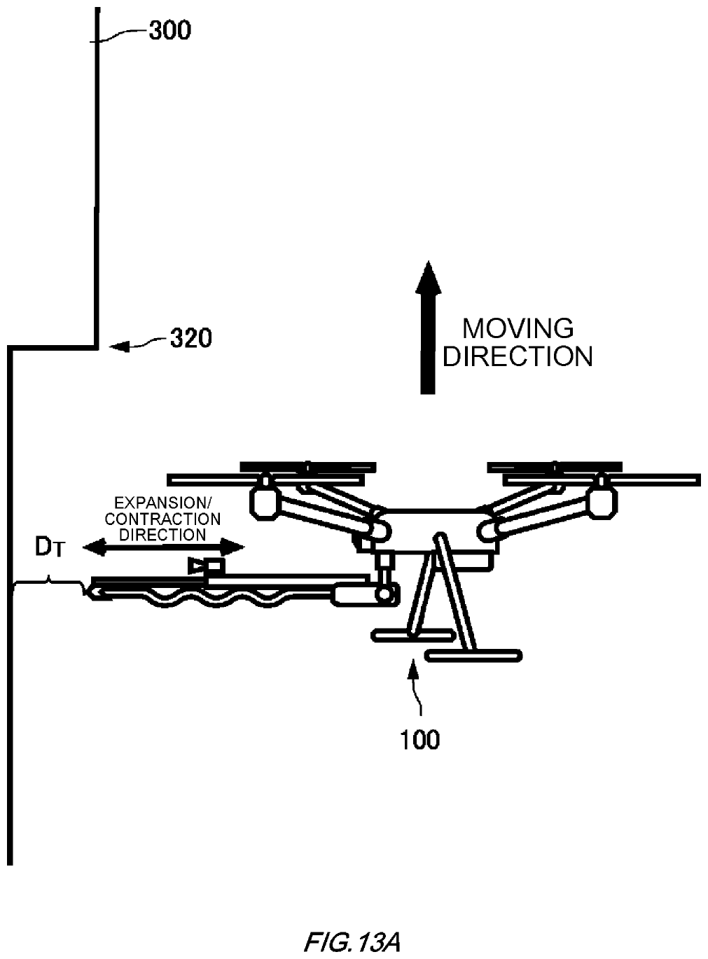

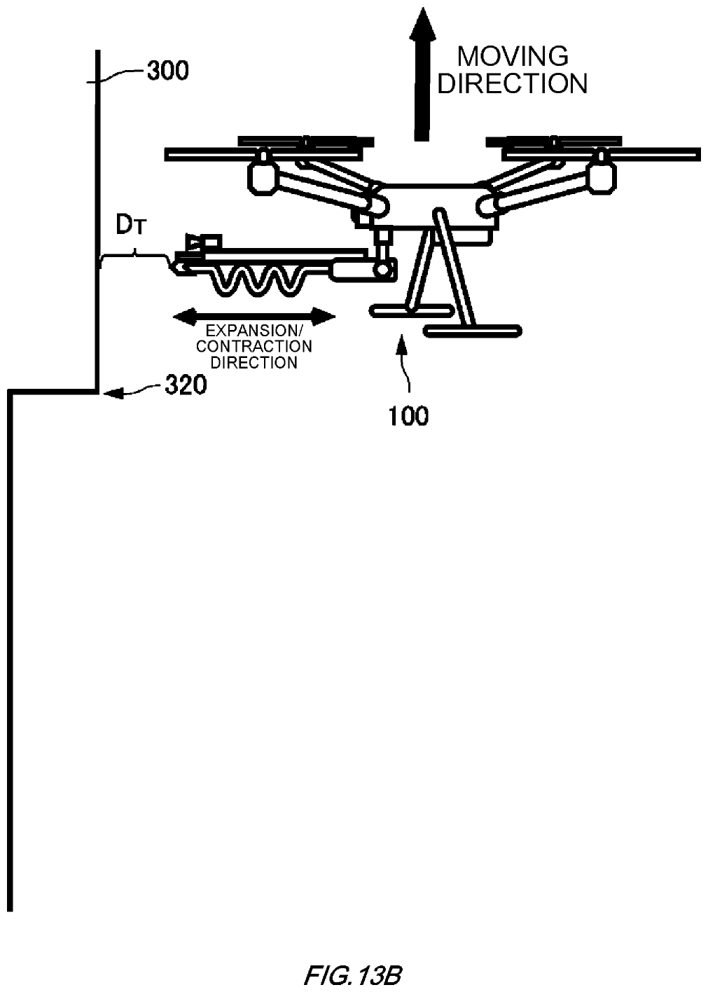

The unmanned aerial vehicle 100 of the present example includes the distance measuring sensor 77 in the expansion/contraction unit 40. The distance measuring sensor 77 may be provided side by side with the discharge port 60. The distance measuring sensor 77 measures a distance D_{T} between the discharge target 300 and the discharge port 60 described below with reference to FIG. 13A. Since the distance measuring sensor 77 is provided in the expansion/contraction unit 40, the distance D_{T} between the discharge target 300 and the discharge port 60 provided at the distal end of the expansion/contraction unit 40 can be accurately measured.

FIG. 1D illustrates an example of a side view of the unmanned aerial vehicle 100 with the distance measuring sensor 77. In the present example, particularly, a difference from the example of FIG. 1C will be mainly described.

A location where the distance measuring sensor 77 is provided is not limited to the expansion/contraction unit 40. In the present example, the distance measuring sensor 77 is provided in the main body 10.

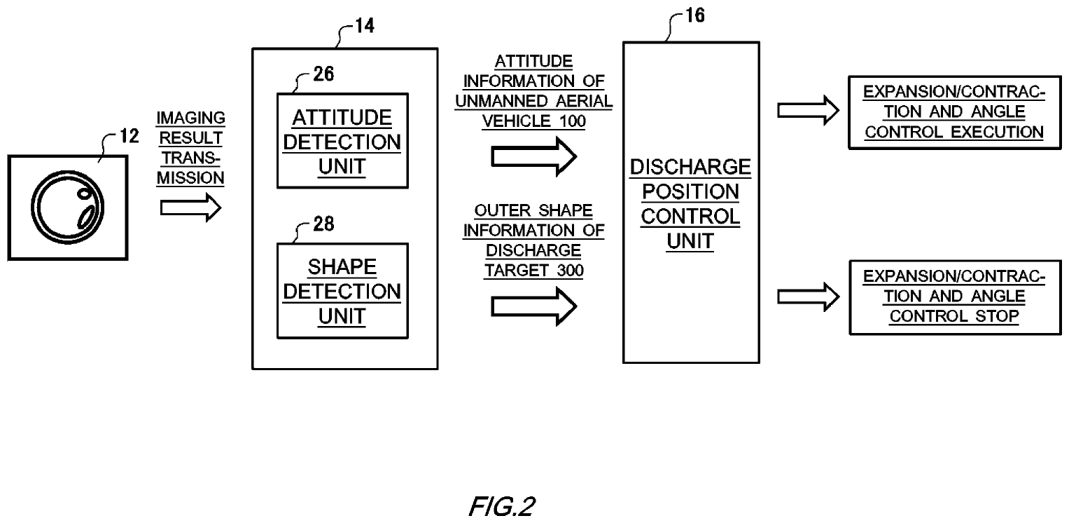

FIG. 2 illustrates an outline of a block diagram regarding the function of the discharge position control unit 16. The discharge position control unit 16 controls the expansion/contraction unit 40 detected by the acquisition unit 14.

The imaging device 12 captures an image of surroundings of the unmanned aerial vehicle 100. The video captured by the imaging device 12 may be a plurality of still images or a moving image. The video captured by the imaging device 12 is transmitted to the acquisition unit 14. As an example, the acquisition unit 14 may include an attitude detection unit 26 and a shape detection unit 28.

The attitude detection unit 26 detects an attitude during flight. As an example, the acquisition unit 14 includes a sensor device such as a gyroscope, an accelerometer, a proximity sensor, or an inertial sensor. The acquisition unit 14 of the present example is electrically connected to the imaging device 12 and receives an image from the imaging device 12. However, the acquisition unit 14 may be provided integrally with the imaging device 12, or may be communicably connected to the imaging device 12. The acquisition unit 14 of the present example analyzes the imaging result of the imaging device 12, and detects whether the attitude of the unmanned aerial vehicle 100 is stable.

The attitude detection unit 26 determines whether the stability of the attitude of the unmanned aerial vehicle 100 is appropriate. The acquisition unit 14 of the present example detects the attitude of the unmanned aerial vehicle 100 on the basis of the imaging result of the imaging device 12, and determines whether the attitude of the unmanned aerial vehicle 100 is stable. However, when the acquisition unit 14 includes a different sensor device such as a gyroscope, an accelerometer, a proximity sensor, or an inertial sensor, the acquisition unit 14 may perform attitude detection on the basis of the measurement result of the different sensor device. Furthermore, the acquisition unit 14 may perform attitude detection by combining the detection result of the imaging device 12 and the measurement result of the different sensor device. The acquisition unit 14 transmits the detection result related to the attitude of unmanned aerial vehicle 100 to the discharge position control unit 16.

The shape detection unit 28 detects the shape of the discharge target 300 to which the contents of the container 70 are discharged. As an example, the shape detection unit 28 performs feature amount extraction on the basis of the video data or the image data captured by the imaging device 12. The feature amount extraction may be performed on the basis of extraction of a feature vector. The shape detection unit 28 performs machine learning on the feature vector and extracts 3D information. Furthermore, the shape detection unit 28 may extract the information such as the material and the temperature of the discharge target 300. The shape detection unit 28 may collect the outer shape information of the discharge target 300 in the form of a 3D map.

The shape detection unit 28 may detect other information of the discharge target 300. As an example, the shape detection unit 28 detects additional information such as the temperature or the material of the discharge target 300. For example, when the imaging device 12 has a function as an infrared camera capable of sensing temperature information, the temperature can be detected by the shape detection unit 28.

As an example, the acquisition unit 14 may acquire the flight information and the control information of the unmanned aerial vehicle 100 by collecting the detection information of the attitude detection unit 26 and the shape detection unit 28. As an example, the acquisition unit 14 acquires a measurement result from the distance measuring sensor 77. In another example, the acquisition unit 14 may communicate with an information processing system such as an external server, transmit the video data or the image data of the imaging device 12, and acquire the flight information and the control information of the unmanned aerial vehicle 100. The acquisition unit 14 transmits the control information of the expansion/contraction unit 40 of the unmanned aerial vehicle 100 to the discharge position control unit 16.

The unmanned aerial vehicle 100 may move on the basis of the flight information acquired by the acquisition unit 14. As an example, the flight information includes map information up to the vicinity of the discharge target 300 acquired by the acquisition unit 14 communicating with an external server. In another example, the flight information includes the 3D information of surroundings of the unmanned aerial vehicle 100, the self-position extraction information of the unmanned aerial vehicle 100, and the like by the imaging device 12 and the shape detection unit 28.

The discharge position control unit 16 receives the control information from the acquisition unit 14. The discharge position control unit 16 controls the expansion/contraction or the angle of the expansion/contraction unit 40 on the basis of the detection result of the acquisition unit 14.

The discharge position control unit 16 may control the expansion/contraction unit 40 on the basis of the detection result of the attitude detection unit 26. The discharge position control unit 16 may be set to perform expansion/contraction control only when the unmanned aerial vehicle 100 is in a predetermined attitude. The discharge position control unit 16 of the present example performs the expansion/contraction control of the expansion/contraction unit 40 in a state where the attitude is stable. That is, in the control, an expansion/contraction operation is permitted only when the attitude of the unmanned aerial vehicle 100 is stable, for example, in a state where the unmanned aerial vehicle 100 stops flying to make a landing on a ground, a water, or the like or in a state the unmanned aerial vehicle 100 is hovering in the air. As a result, it is possible to avoid a situation in which the attitude of the unmanned aerial vehicle 100 is greatly varied by the expansion/contraction operation itself, and to stably perform the expansion/contraction control.

The discharge position control unit 16 may control the expansion/contraction unit 40 on the basis of the detection result of the discharge target 300 of the shape detection unit 28. By the detection of the shape detection unit 28, the angle control or the expansion/contraction control of the expansion/contraction unit 40 can be performed according to the outer shape of the discharge target 300, the distance D_{T} from the discharge target 300 to the unmanned aerial vehicle 100, and the like. As a result, the position and the angle of the discharge port 60 with respect to the discharge target 300 can be adjusted to a condition suitable for the physical properties of the contents. In addition, the discharge position control unit 16 may perform the expansion/contraction control or the angle control of the expansion/contraction unit 40 on the basis of flight information such as a wind speed, a humidity, or a temperature and on the basis of the condition suitable for the contents.

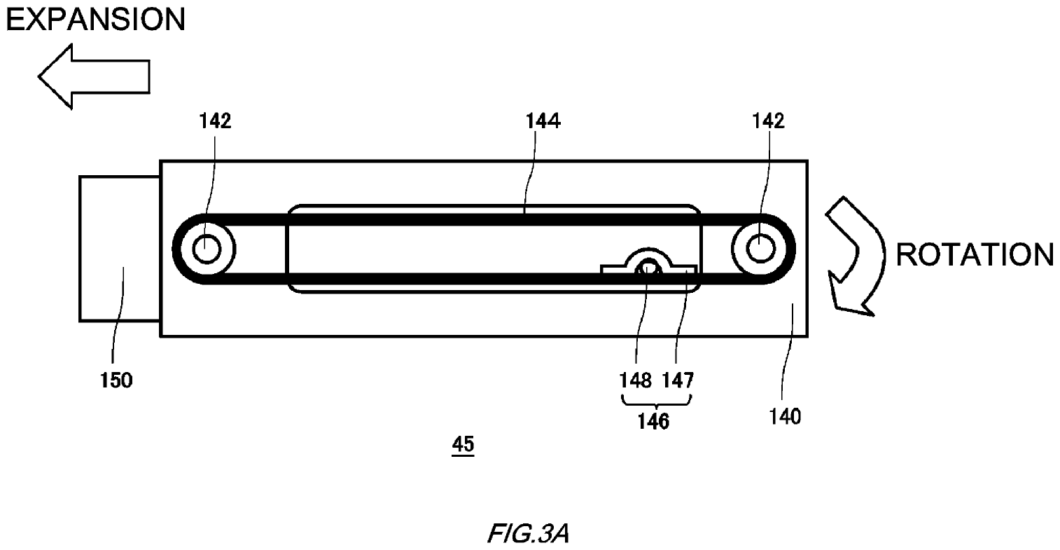

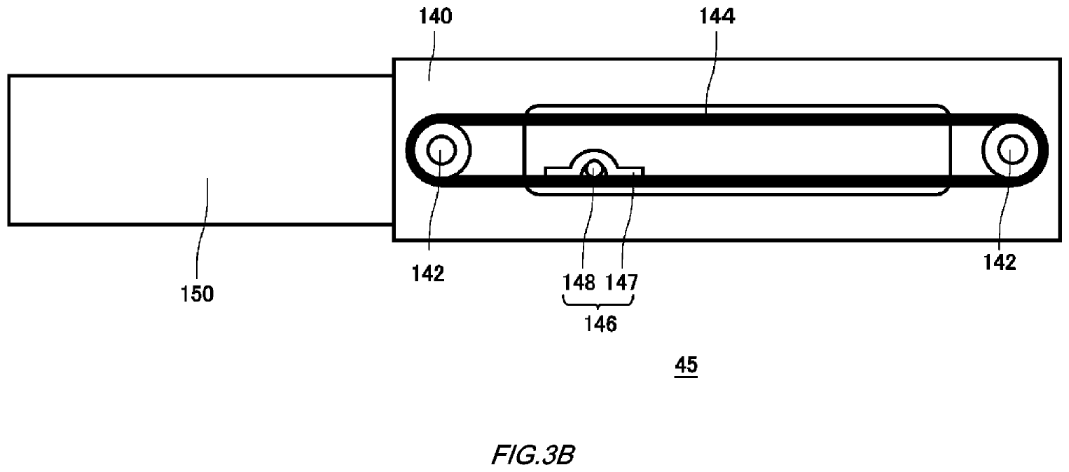

FIG. 3A illustrates an example of the expansion/contraction mechanism 45 in the contracted state. The expansion/contraction mechanism 45 of the present example includes a rod portion 150, a housing 140, a rotation portion 142, a linking portion 144, and a rod fixing portion 146 fixed to the linking portion 144. The expansion/contraction mechanism 45 of the present example operates regardless of a pressure.

A part of the rod portion 150 is provided in the housing 140, and the other part protrudes to the outside of the housing 140. The rod portion 150 of the present example is provided with metal. However, the rod portion 150 has a rigidity. The rod portion 150 is connected to the tube portion 65. When the length of the rod portion 150 protruding from the housing 140 varies, the tube portion 65 is expanded/contracted.

The rotation portion 142 rotates by being connected to a drive mechanism such as a motor. A plurality of the rotation portions 142 may be provided, and are engaged with the linking portion 144 without causing leaping due to disengagement, slippage, or the like. The rotation portion 142 may be a pulley or a gear.

The linking portion 144 extends between the rotation portion 142. The linking portion 144 may be a belt or a chain. The linking portion 144 rotates in the same direction as the rotation portion 142 according to the rotation of the rotation portion 142.

The rod fixing portion 146 fixes the rod portion 150 on the linking portion 144. As an example, the rod fixing portion 146 includes a shaft pin 148 which extends from the side surface of the rod portion 150 and a clamp 147 which clamps the shaft pin 148 and fixes the shaft pin on the linking portion 144. However, the structure of the rod fixing portion 146 is not limited to the clamp 147 and the shaft pin 148 as long as the rod portion 150 can be fixed on the linking portion 144.

Since the shaft pin 148 is fixed on the linking portion 144 by the clamp 147, the shaft pin 148 translationally moves with the rotation of the rotation portion 142. Due to the translational movement, the rod portion 150 also translationally moves with respect to the housing 140, and the length of the rod portion 150 protruding from the housing 140 varies.

FIG. 3B illustrates an example of the expansion/contraction mechanism 45 in the expanded state. In the present example, a state where the length of the rod portion 150 protruding from the housing is increased is illustrated. Hereinafter, a difference from FIG. 3A will be mainly described.

In the present example, the rod fixing portion 146 moves to the side surface side of the housing 140 from which the rod portion 150 protrudes. As a result, the length of the rod portion 150 protruding from the housing 140 increases.

When the rotation portion 142 is rotated in the direction opposite to the direction in which the expansion/contraction unit 40 operates in the expanding direction, the rod fixing portion 146 is moved to the side opposite to the side surface on which the rod portion 150 protrudes from the housing 140. As a result, a larger portion of the rod portion 150 is stored in the housing 140, and the expansion/contraction unit 40 contracts.

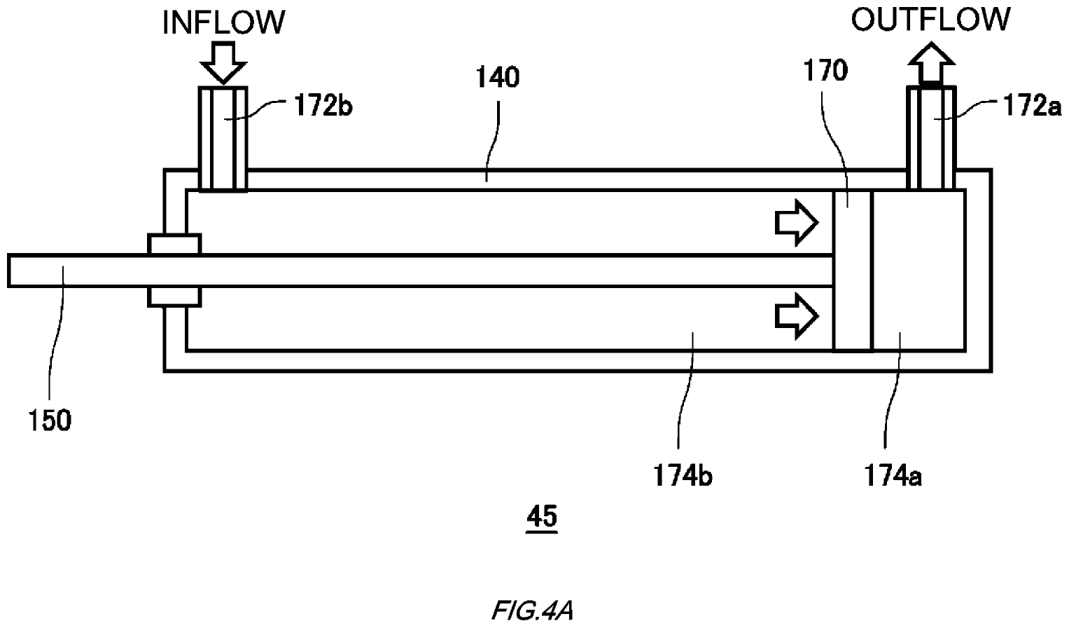

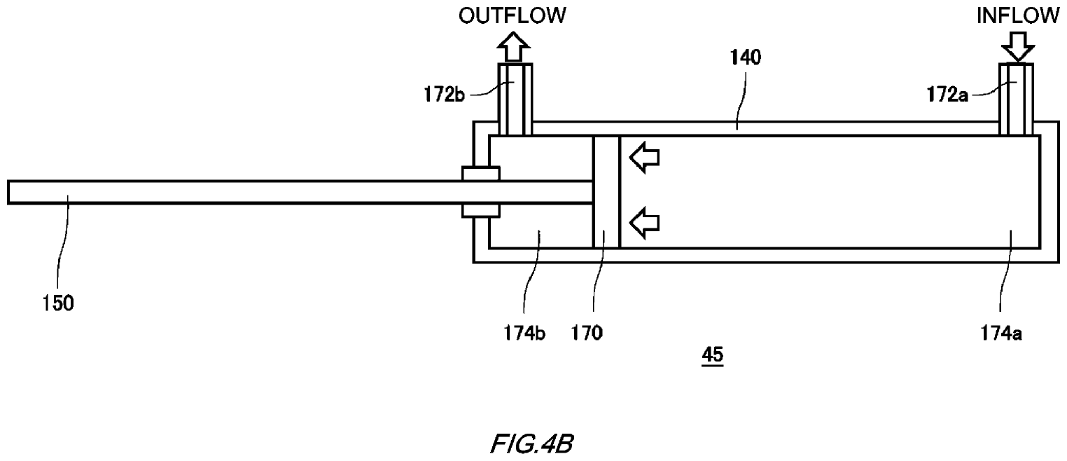

FIG. 4A illustrates another example of the expansion/contraction mechanism 45 in a contraction transient state. The expansion/contraction mechanism 45 of the present example is a piston cylinder which expands/contracts due to variation in internal pressure. The expansion/contraction mechanism 45 includes the housing 140, the rod portion 150 provided to at least partially protrude from the housing 140, a drive portion 170 provided at the end of the rod portion 150 inside the housing 140, a pressure supply port 172 provided in the housing 140, and each region 174 partitioned by the drive portion 170 inside the housing. The expansion/contraction mechanism 45 of the present example operates by a pressure difference applied to the drive portion 170.

A plurality of the pressure supply ports 172 may be provided near the end of the housing 140 in the extending direction. As an example, a pressure supply port 172b is provided in the vicinity of the side surface on the side on which the rod portion 150 protrudes from the housing 140. On the other hand, a pressure supply port 172a is provided in the vicinity of the side surface opposing the side surface on which the rod portion 150 protrudes from the housing 140.

Each internal region 174 of the housing 140 is partitioned by the drive portion 170. In each internal region 174 of the housing 140, a region on the pressure supply port 172a side is defined as a region 174a, and a region on the pressure supply port 172b side is defined as a region 174b. The rod portion 150 is operated by a pressure difference between the regions 174a and 174b partitioned by the drive portion 170 in the housing 140.

A fluid flows out or in through the pressure supply port 172. In the present example, the fluid flows out from the housing 140 through the pressure supply port 172a, and the pressure in the region 174a decreases. On the other hand, the fluid flows into the housing 140 through the pressure supply port 172b, and the pressure in the region 174b increases. As a result, the pressure on the drive portion 170 in the region 174a becomes smaller than the pressure on the drive portion 170 in the region 174b. Therefore, the drive portion 170 translationally moves in the direction toward the inside of the housing, and the length of the rod portion 150 protruding from the housing 140 decreases. It is sufficient if a pressure difference is generated in the region 174a and the region 174b, and it is sufficient if at least one of the outflow of the fluid through the pressure supply port 172a and the inflow of the fluid through the pressure supply port 172b is performed.

The fluids provided in the region 174a and the region 174b may be a gas or a liquid. That is, when the fluid is a gas, the drive portion 170 moves due to the air pressure difference inside the housing 140 and varies the length of the rod portion 150 protruding from the housing 140. In addition, the fluids filling the region 174a and the region 174b may be different types of fluids.

FIG. 4B illustrates another example of the expansion/contraction mechanism 45 in an expansion transient state. In the present example, a state where the length of the rod portion 150 protruding from the housing is increased is illustrated. A difference from FIG. 4A will be mainly described below.

In the present example, the fluid flows into the housing 140 through the pressure supply port 172a, and the pressure in the region 174a increases. On the other hand, the fluid flows out from the housing 140 through the pressure supply port 172b, and the pressure in the region 174b decreases. As a result, the pressure on the drive portion 170 in the region 174a becomes larger than the pressure on the drive portion 170 in the region 174b. Therefore, the drive portion 170 translationally moves in the direction toward the inside of the housing, and the length of the rod portion 150 protruding from the housing 140 decreases. It is sufficient if a pressure difference is generated in the region 174a and the region 174b, and It is sufficient if at least one of the inflow of the fluid through the pressure supply port 172a and the outflow of the fluid through the pressure supply port 172b is performed.

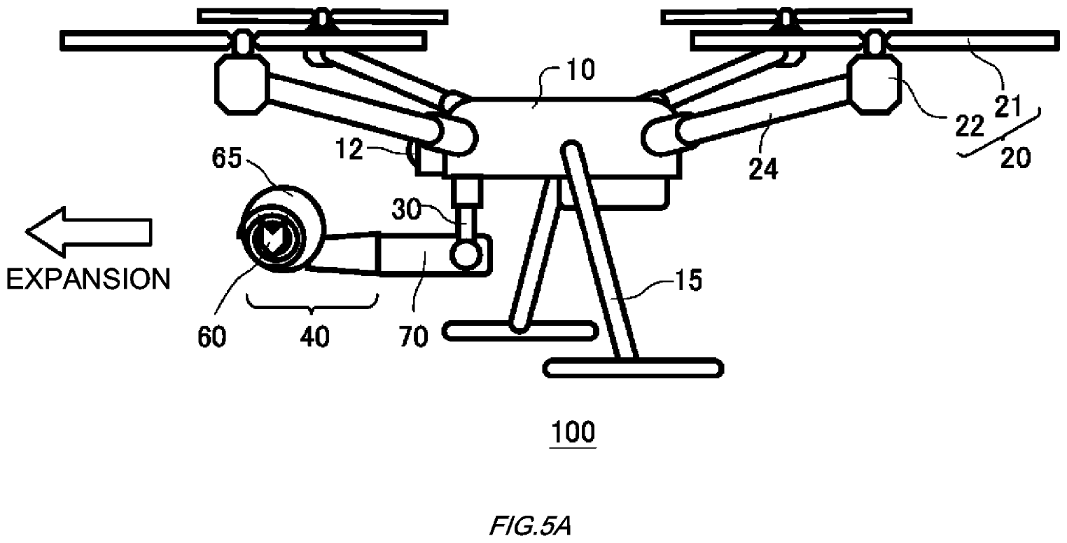

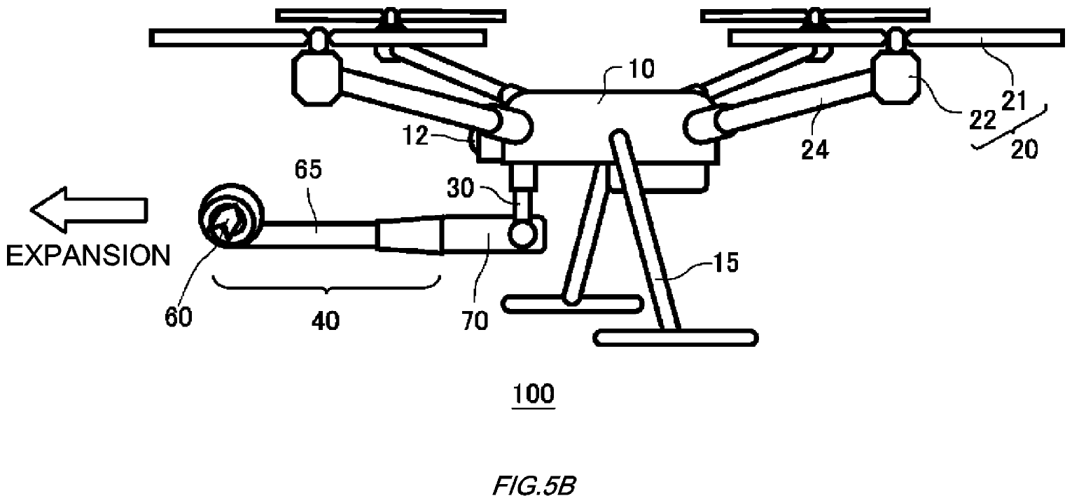

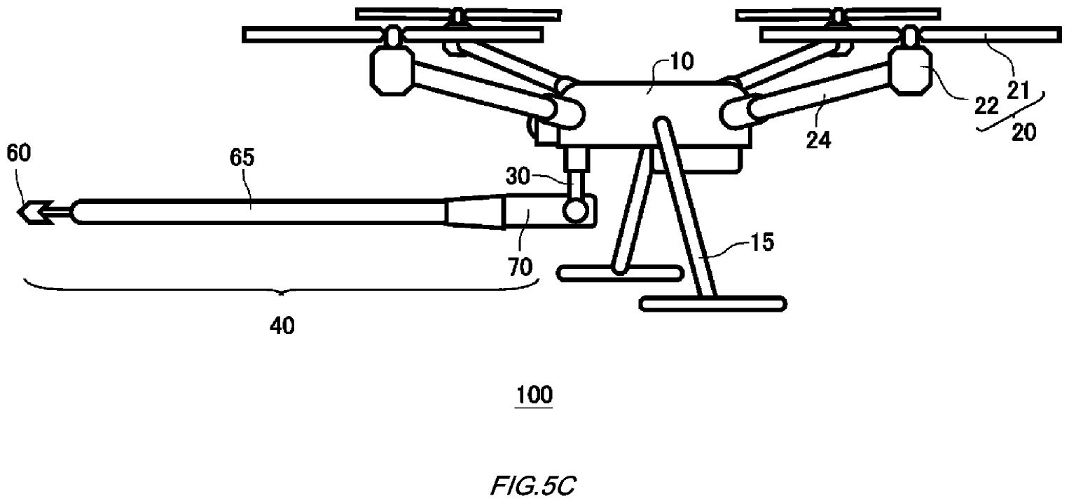

FIG. 5A illustrates an example of a side view of the unmanned aerial vehicle 100 in the contracted state in which the expansion/contraction mechanism 45 is operated with the pressure supplied from the container 70. When the contents are injected from the container 70 into the tube portion 65, the tube portion 65 extruded by the contents expands.

The tube portion 65 of the present example has an elasticity, rotates in a predetermined direction in the contracted state, and is wound toward the container 70. However, the elasticity of the tube portion 65 is low, and by setting the pressure applied by the contents to a predetermined magnitude, the tube portion 65 can be expanded only by an extrusion force caused by the injection of the content. The contents are discharged to the target from the discharge port 60 provided at the end of the expanded tube portion 65.

In the present example, the expansion/contraction unit 40 can be operated without providing a pressure source other than the container 70. Furthermore, in the expansion/contraction unit 40, the expansion/contraction operation can be implemented without providing the expansion/contraction mechanism 45 other than the tube portion 65.

FIG. 5B illustrates an example of a side view of the unmanned aerial vehicle 100 in the expansion transient state in which the expansion/contraction mechanism 45 is operated with the pressure supplied from the container 70. The unmanned aerial vehicle 100 is illustrated in a state where the tube portion 65 is in the middle of being expanded by injecting the contents from the container 70 into the tube portion 65.

FIG. 5C illustrates an example of a side view of the unmanned aerial vehicle 100 in the expanded state in which the expansion/contraction mechanism 45 is operated with the pressure supplied from the container 70. When the pressure provision from the container 70 to the tube portion 65 is stopped or when the contents are sucked from the tube portion 65 to the container 70, the tube portion 65 starts the contraction operation. Since the tube portion 65 has an elasticity, the tube portion rotates in the predetermined direction in the contracted state and is wound toward the container 70.

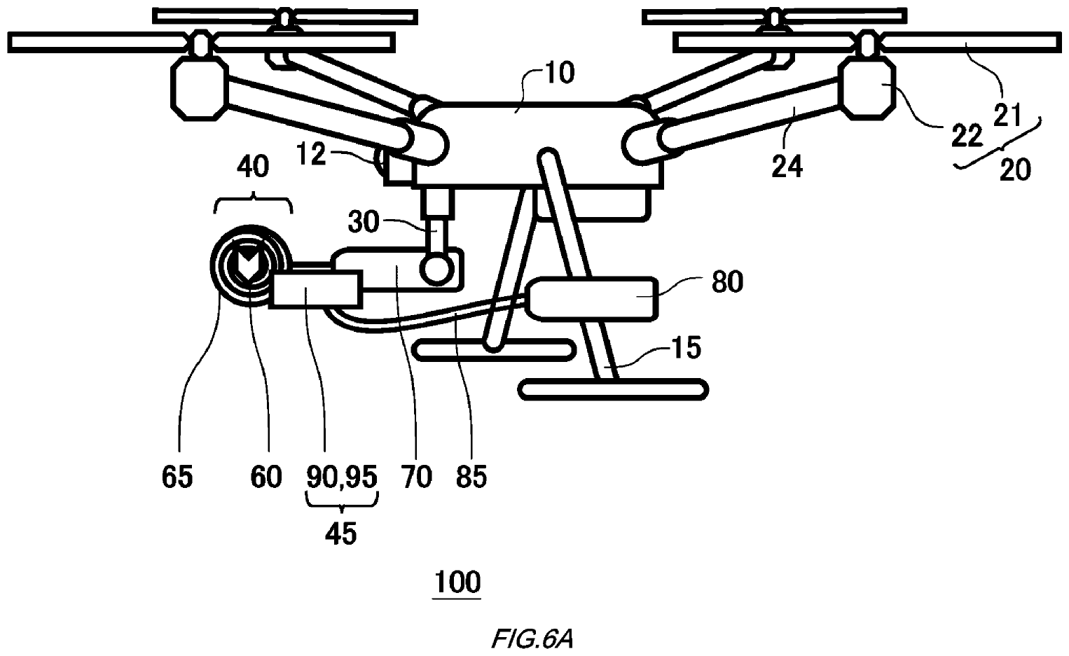

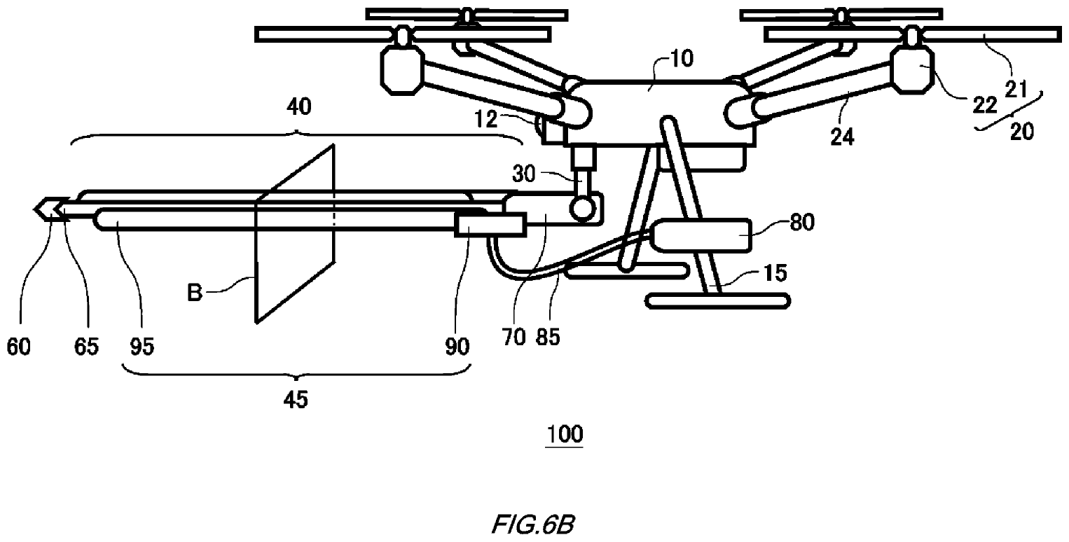

FIG. 6A illustrates another example of a side view of the unmanned aerial vehicle 100 in the contracted state in which the expansion/contraction mechanism 45 is operated with the pressure supplied from the container 70. Hereinafter, a description will be given focusing on a difference from the example of FIG. 5A. The unmanned aerial vehicle 100 of the present example includes a pressure source 80 and a pressure supply path 85.

The expansion/contraction mechanism 45 of the present example includes a pressure supply unit 90 and a balloon structure portion 95. The balloon structure portion 95 is inflated when the internal pressure increases.

The pressure supply unit 90 is in fluid communication with the pressure source 80 via the pressure supply path 85. The pressure supply unit 90 fixes the inlet of the balloon structure portion 95. In another example, the pressure supply unit 90 may have a valve for controlling the flow of fluid from the pressure source 80 or the balloon structure portion 95, and may have a suction device which sucks fluid from the balloon structure portion 95.

The fluid stored inside the pressure source 80 is injected from the pressure source 80 into the balloon structure portion 95 via the pressure supply path 85. As a result, the balloon structure portion 95 is filled with the fluid and inflated, and the expansion/contraction unit 40 is expanded by the inflation of the balloon structure portion 95. That is, the pressure source 80 varies the internal pressure of the expansion/contraction unit 40, and the expansion/contraction unit 40 expands/contracts due to the internal pressure variation.

As an example, the fluid supplied by the pressure source 80 is a gas, but is not limited thereto. When the pressure source 80 supplies a gas, the pressure source 80 varies the internal air pressure of the expansion/contraction unit 40. In this case, the pressure source 80 may be an aerosol container. When a pressure-resistant container such as an aerosol container is used as the pressure source 80, a liquefied gas may be used as the fluid. In that case, the liquefied gas may be vaporized in the pressure supply path 85 or the balloon structure portion 95 to generate a pressure.

The balloon structure portion 95 may be provided to have a structure bonded to pipe section 65 to translate adjacent the tube portion 65. Thus, when the balloon structure portion 95 is inflated and expanded, the translating tube portion 65 is also expanded. Two balloon structure portions 95 of the present example are provided side by side with the tube portion 65. However, a different number of balloon structure portion 95 may be provided.

In the present example, the pressure source 80 provided separately from the container 70 provides a pressure for expanding the expansion/contraction unit 40. Accordingly, the pressure source 80 can be provide a pressure greater than the pressure provided from the container 70 to the balloon structure portion 95. As a result, the tube portion 65 has a high elasticity, and can be expanded even when it is difficult to expand. In addition, even when the provision of the contents to be discharged from the container 70 is stopped in the middle, the tube portion 65 can be maintained in the expanded state.

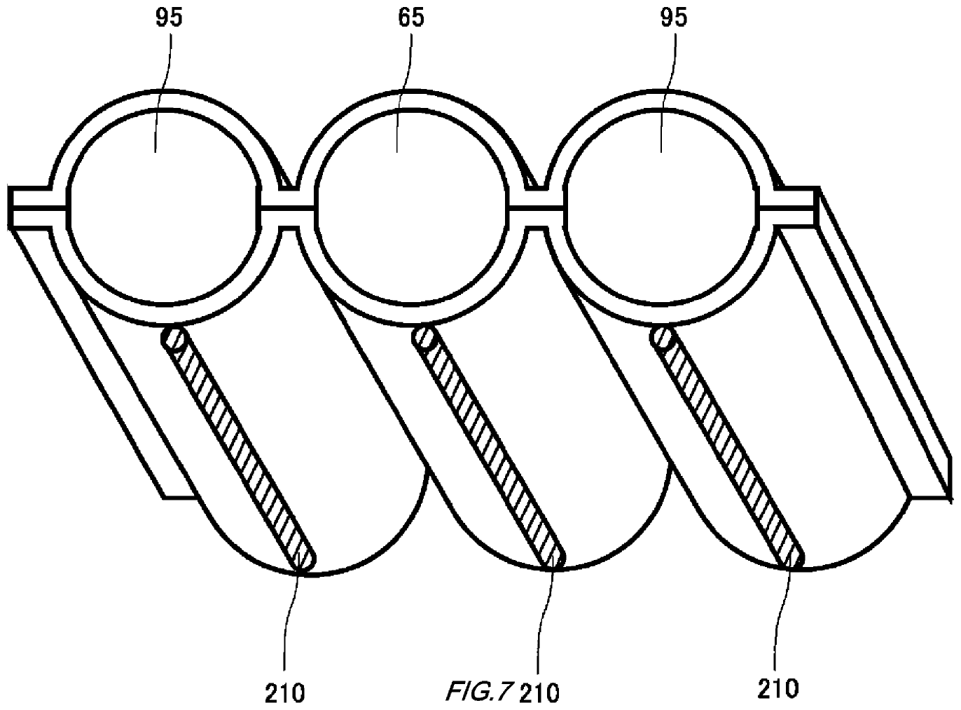

The tube portion 65 of the present example may have an elasticity for rotating and contracting in the predetermined direction in the contracted state. However, the tube portion 65 may separately include an elastic body 210 described below in FIG. 7.

FIG. 6B illustrates an example of a side view of the unmanned aerial vehicle 100 in the expanded state in which the expansion/contraction mechanism 45 is operated with the pressure supplied from the container 70. In the present example, two balloon structure portions 95 are expanded and the translating tube portion 65 is also expanded.

FIG. 7 illustrates an example of a cross-sectional perspective view of the expansion/contraction unit 40. The present example is an example of a perspective view in which a predetermined distance from a cross section cut by a plane B of FIG. 6B to the unmanned aerial vehicle 100 side is displayed.

The expansion/contraction unit 40 includes the elastic body 210. The expansion/contraction unit 40 contracts due to the restoring force of the elastic body 210.

As an example, the elastic body 210 may be rubber and may include a spring. The steady state of the elastic body 210 is set to a state in which the expansion/contraction unit 40 expands/contracts. When the balloon structure portion 95 is filled with fluid and the tube portion 65 is in the expanded state, a force, which is stronger than the restoring force, in the expanding direction is applied. On the other hand, when the fluid is removed from the balloon structure portion 95, the elastic body 210 contracts the expansion/contraction unit 40 by the restoring force.

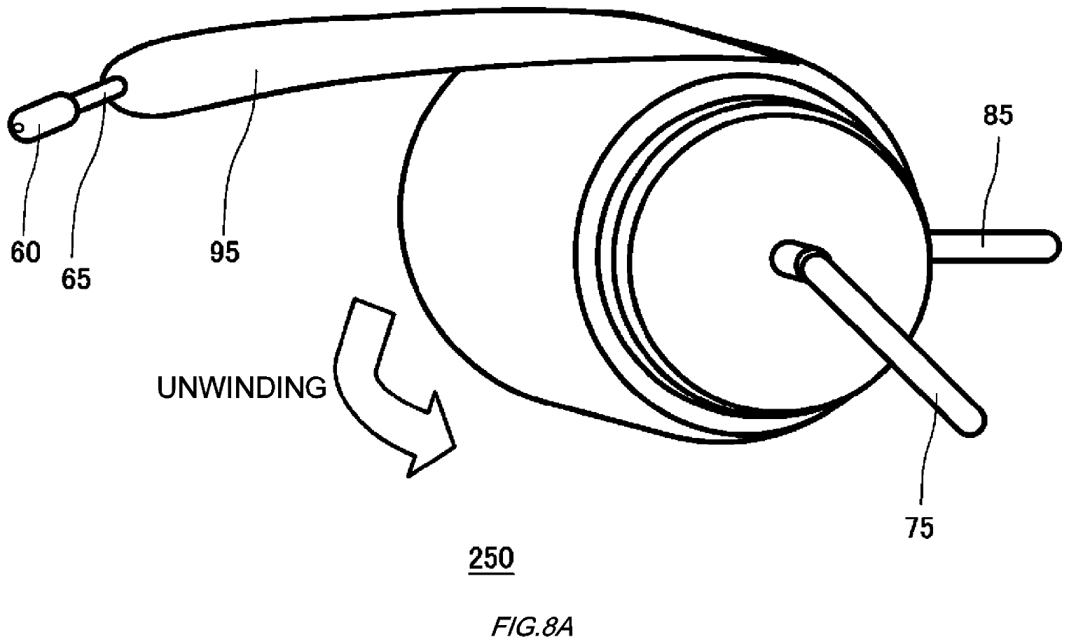

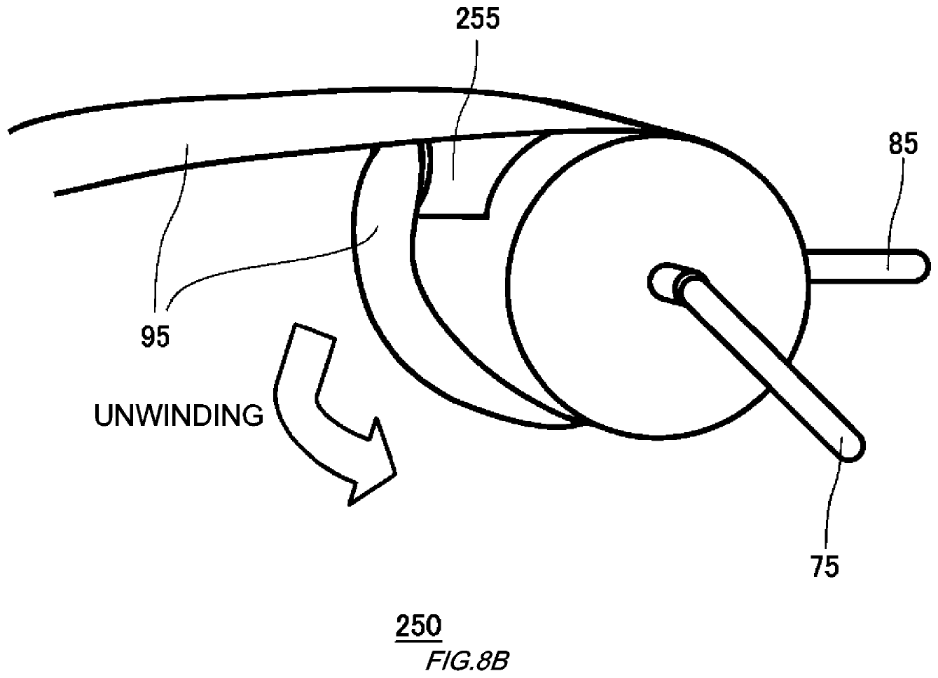

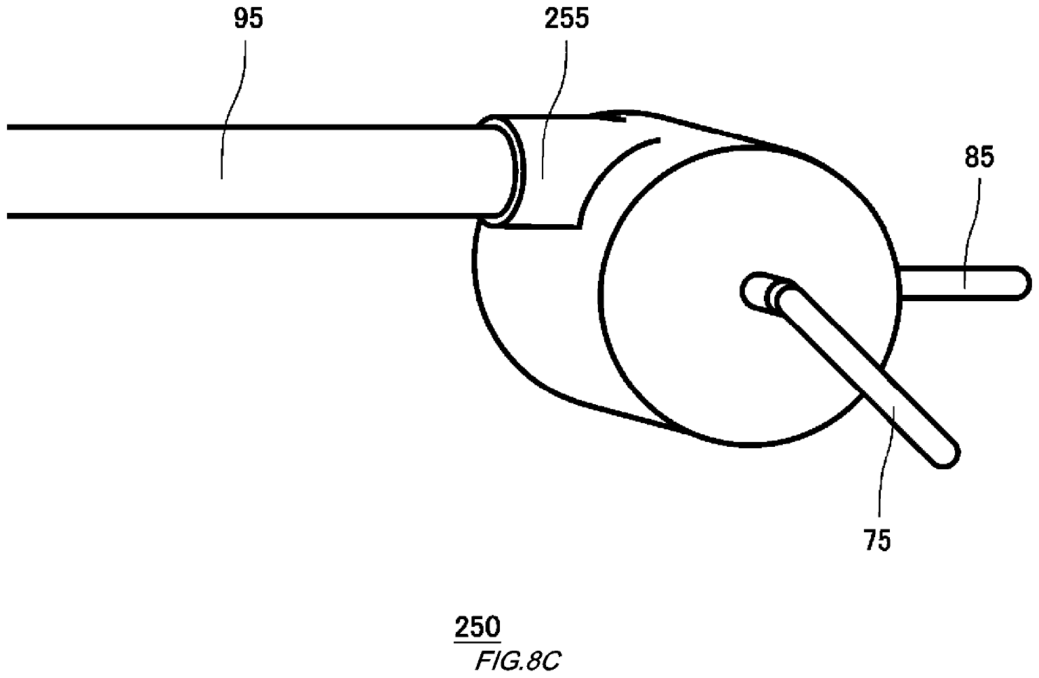

FIG. 8A illustrates an example of a winding unit 250 in a state where the expansion/contraction unit 40 is in the contracted state. The winding unit 250 of the present example is connected to a drive device such as a motor, and rotates in both directions of an unwinding direction and a winding direction by changing the polarity of the current applied to the motor.

When the winding unit 250 rotates in the unwinding direction, the tube portion 65 and the balloon structure portion 95 wound by the winding unit 250 are unwound, and the expansion/contraction unit 40 expands. In the present example, a flow path 75, which is a supply path of the contents in the container 70, and the pressure supply path 85 are connected to the winding unit 250.

The balloon structure portion 95 of the present example is provided to cover the tube portion 65 in a radial direction. The expansion of the expansion/contraction unit 40 of the present example may be performed on the basis of both the pressure by the inflow of the fluid to the balloon structure portion 95 via the pressure supply path 85 and the unwinding by the rotational operation of the winding unit 250 in the unwinding direction. In order to provide the tube portion 65 and the balloon structure portion 95 in a windable manner, the tube portion 65 and the balloon structure portion 95 are provided with a material having a flexibility. Due to the inflation of the balloon structure portion 95, the tube portion 65 and the balloon structure portion 95 are expanded, and the discharge port 60 easily aims at the target.

FIG. 8B illustrates an example of the winding unit 250 in a state where the expansion/contraction unit 40 is in the expansion transient state. In the present example, the winding unit 250 further continues to rotate in the unwinding direction from the state of FIG. 8A. In the present example, a winding outlet 255 provided along the circumferential direction of the winding unit 250 appears. The balloon structure portion 95 is unwound in the circumferential direction of the winding unit 250 from the winding outlet 255.

FIG. 8C illustrates an example of the winding unit 250 in a state where the expansion/contraction unit 40 is in the expanded state. In the present example, the tube portion 65 and the balloon structure portion 95 are completely unwound, and the balloon structure portion 95 is filled with fluid.

In the examples of FIGS. 8A to 8C, an example in which the winding unit 250 rotates in the unwinding direction and the tube portion 65 is unwound is illustrated. On the other hand, when the expansion/contraction unit 40 is contracted, the winding unit 250 may rotate in the winding direction, which is the direction opposite to the unwinding direction, and the tube portion 65 and the balloon structure portion 95 may be wound to perform the contraction. That is, the winding unit 250 winds the expansion/contraction unit 40 by the rotational operation to contract the expansion/contraction unit 40.

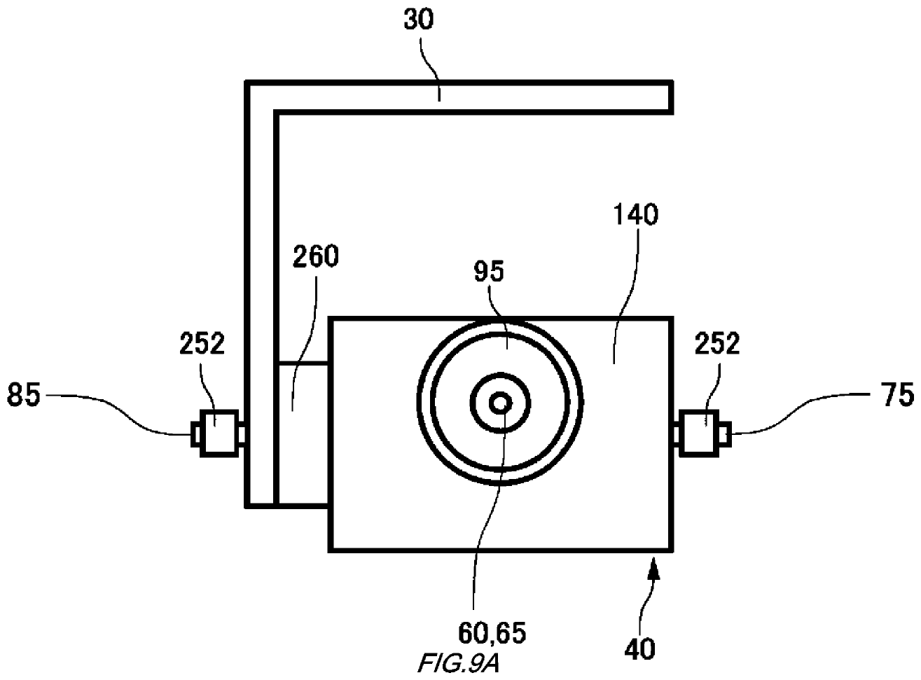

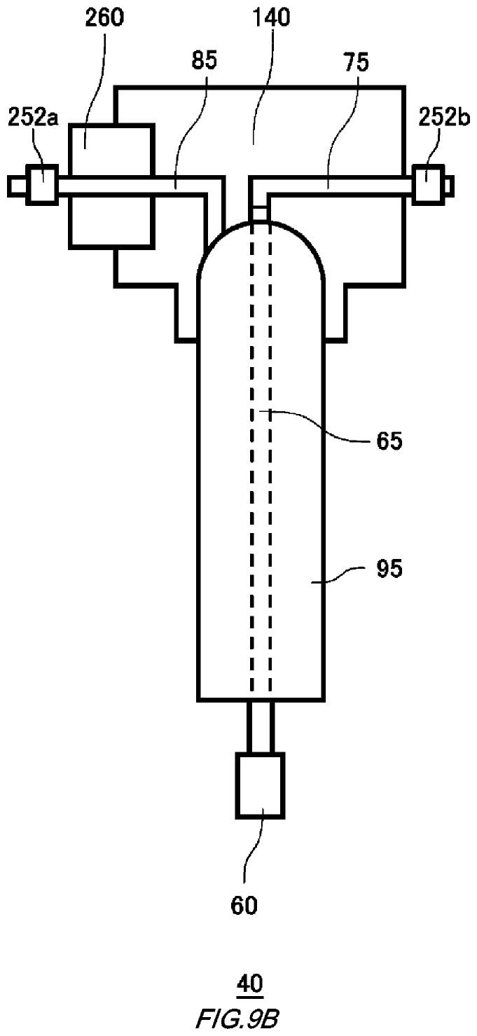

FIG. 9A illustrates an example of a front view of the support portion 30 and the expansion/contraction unit 40. The support portion 30 of the present example is a suspension frame. The flow path 75 and the pressure supply path 85 are connected to the expansion/contraction unit 40 of the present example.

The expansion/contraction unit 40 of the present example includes the housing 140, the discharge port 60, the tube portion 65, the balloon structure portion 95, a rotary joint 252, and a hollow motor 260. The housing 140 in the present example is a drum housing.

The rotary joints 252 are provided near boundaries on the flow path 75 and the pressure supply path 85 with respect to the housing 140 for the flow path 75 side and the pressure supply path 85 side, respectively. The expansion/contraction unit 40 is connected to the flow path 75 and the pressure supply path 85 via the rotary joint 252. The rotary joint 252 prevents the flow path 75 and the pressure supply path 85 from being twisted during the rotational operation of the expansion/contraction unit 40.

The hollow motor 260 rotates the housing 140. When the hollow motor 260 operates, the expansion/contraction unit 40 has a function as the winding unit 250. However, the winding unit 250 may be provided side by side with the expansion/contraction unit 40.

FIG. 9B illustrates an example of a schematic cross-sectional view of an upper surface of the expansion/contraction unit 40. The flow path 75 and the pressure supply path 85 are disposed inside the housing 140. Note that a part of the pressure supply path 85 penetrates the inside of the hollow motor 260.

The balloon structure portion 95 is connected to the pressure supply path 85. The balloon structure portion 95 is supplied with fluid via the pressure supply path 85. The inside of the balloon structure portion 95 is filled with the fluid to inflate the balloon structure portion 95.

The tube portion 65 is connected to the flow path 75. The contents of the container 70 are provided to the discharge port 60 via the tube portion 65 disposed inside the balloon structure portion 95. The tube portion 65 may be formed of an elastic body having a flexibility, and the flow path 75 may be provided inside the housing 140 by a member having a rigidity.

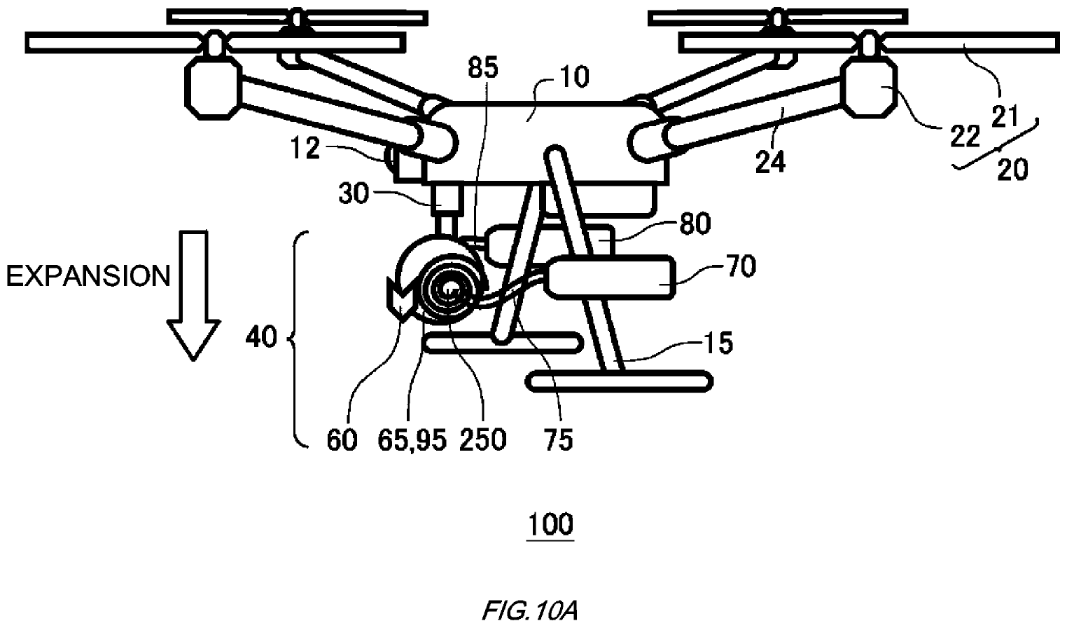

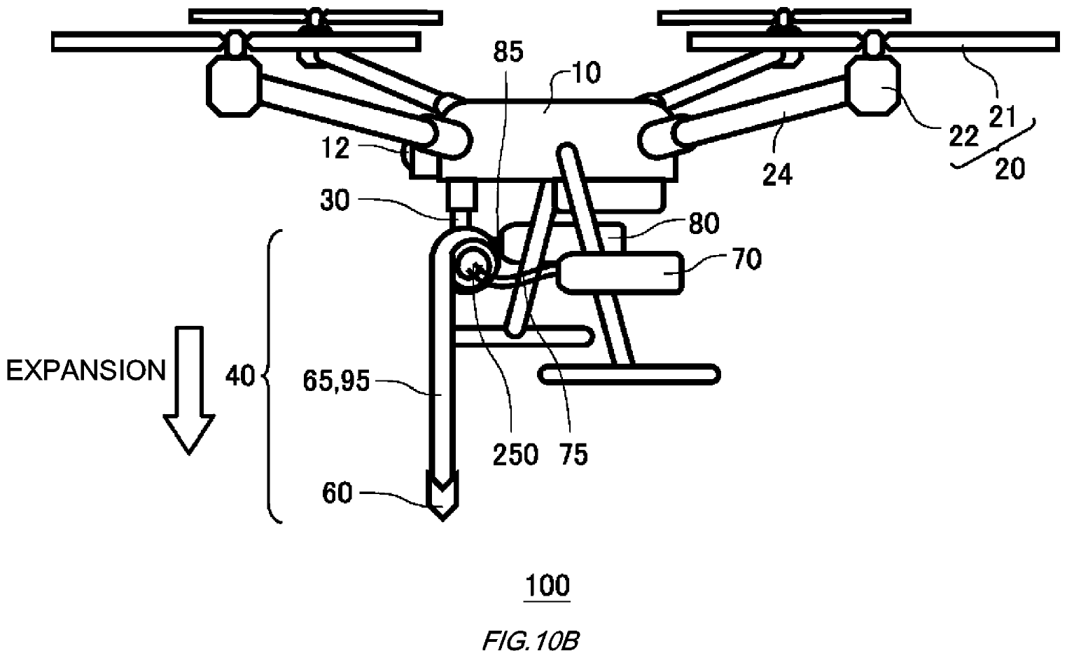

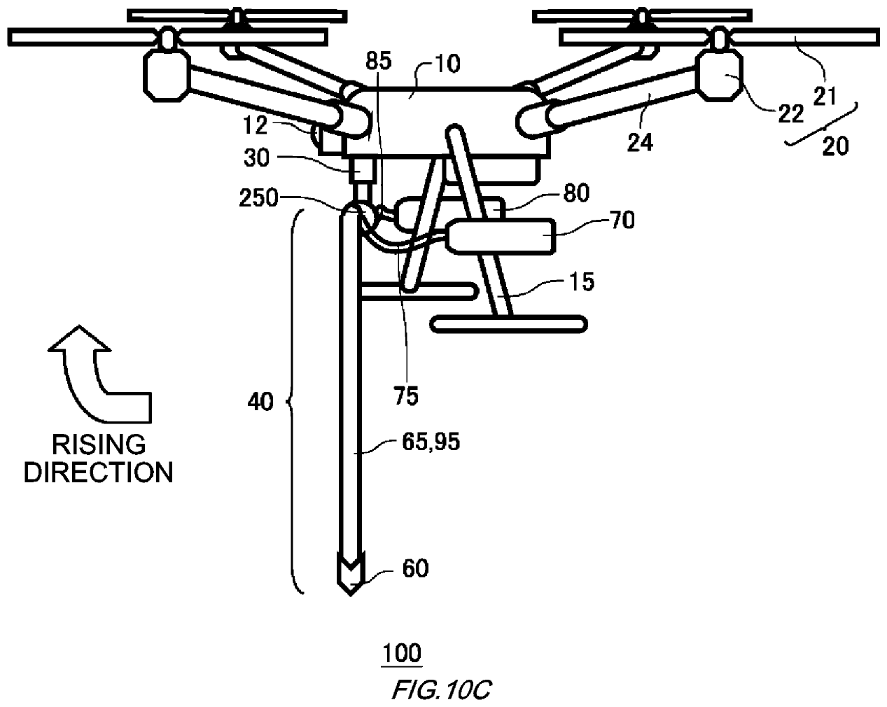

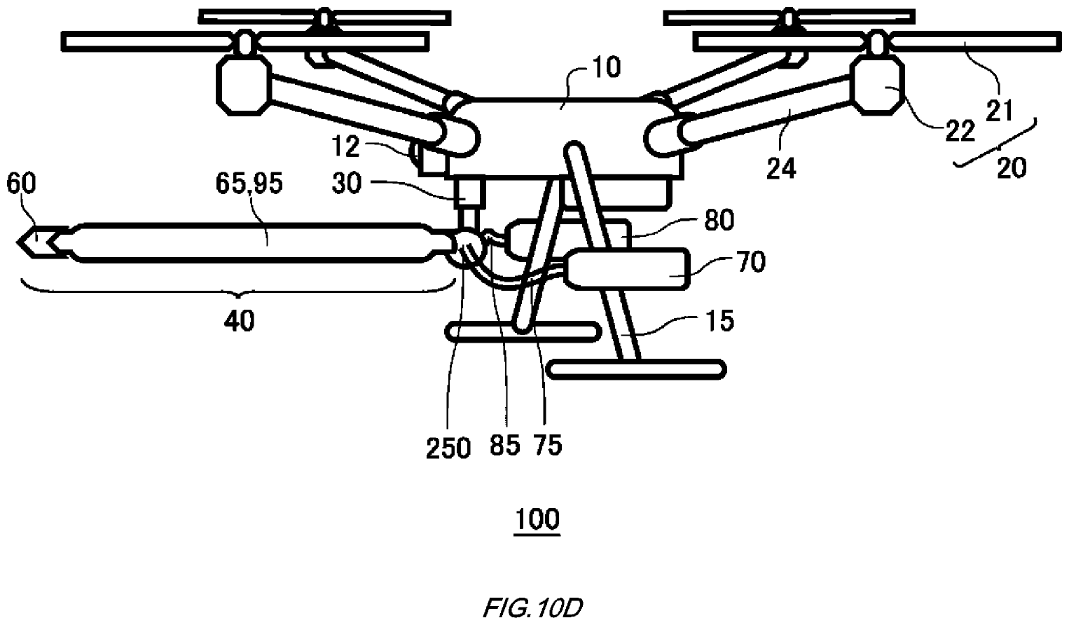

FIG. 10A illustrates an example of a side view of the unmanned aerial vehicle 100 having the winding unit 250 in a state where the expansion/contraction unit 40 is in the contracted state. The unmanned aerial vehicle 100 of the present example includes the winding unit 250 illustrated in FIGS. 8A to 9B. In addition, the unmanned aerial vehicle 100 of the present example includes both the container 70 and the pressure source 80.

In the present example, each of the container 70 and the pressure source 80 is fixed to the leg portion 15. However, each of the container 70 and the pressure source 80 may be fixed to the unmanned aerial vehicle 100 in a different manner. For example, an additional support portion 30 may be provided to fix the container 70 and the pressure source 80.

The winding unit 250 unwinds the tube portion 65 and the balloon structure portion 95. The tube portion 65 and the balloon structure portion 95 of the expansion/contraction unit 40 are expanded by unwinding the winding unit 250. However, the injection of the contents into the tube portion 65 and the injection of the fluid into the balloon structure portion 95 may be performed in parallel with the unwinding of the tube portion 65 and the balloon structure portion 95, and the expansion of the expansion/contraction unit 40 may be performed by another mechanism in parallel with the unwinding of the winding unit 250.

FIG. 10B illustrates an example of a side view of the unmanned aerial vehicle 100 having the winding unit 250 in a state where the expansion/contraction unit 40 is in the expansion transient state. In the present example, when the unmanned aerial vehicle 100 is in a hovering state in which the unmanned aerial vehicle stops in the air without changing its attitude at a predetermined position during flight, the tube portion 65 and the balloon structure portion 95 are unwound vertically downward.

When the tube portion 65 and the balloon structure portion 95 are unwound vertically downward as in the present example, a possibility that the tube portion 65 collides with a surrounding obstacle or the like during unwinding can be reduced. However, for example, when the inflation is performed while injecting contents into the tube portion 65 or fluid into the balloon structure portion 95, the tube portion 65 and the balloon structure portion 95 may be unwound in a different desired direction.

FIG. 10C illustrates an example of a side view of the unmanned aerial vehicle 100 having the winding unit 250 in a state where the expansion/contraction unit 40 is in the expanded state. In the present example, after the expansion of the tube portion 65 and the balloon structure portion 95 is completed, the injection of contents into the tube portion 65 and the injection of fluid from the pressure source 80 into the balloon structure portion 95 are performed.

The fluid injected into balloon structure portion 95 may be a gas or a liquefied gas. When the inside of the balloon structure portion 95 is filled with the fluid, the expansion/contraction unit 40 rises due to the structure maintaining force caused by the internal pressure. The balloon structure portion 95 of the present example includes a structure that bulges linearly. However, a shape when the balloon structure portion 95 is inflated is not limited to the linear shape, and may be a desired shape according to the position of the discharge target 300 of the contents or the like. When the balloon structure portion 95 is filled with the contents, the expansion/contraction unit 40 rises in a rising direction and is directed toward the discharge target 300. The direction of the balloon structure portion 95 may be fixed by the winding unit 250 after rising to a predetermined direction. Furthermore, the entire expansion/contraction unit 40 may be directed toward the discharge target 300 by an external force applied by the drive mechanism such as a motor.

FIG. 10D illustrates an example of a side view of the unmanned aerial vehicle 100 having the winding unit 250 in the discharge preparation completed state of the tube portion 65. In the present example, the balloon structure portion 95 rises due to the structure maintaining force caused by the internal pressure of the injected fluid, and is directed in the direction of the discharge target 300. However, the injection of the fluid into balloon structure portion 95 may be performed in the middle of unwinding the tube portion 65. In the present example, the inflated balloon structure portion 95 is held by the winding outlet 255, so that the discharge port 60 is directed in the direction of the discharge target 300.

The tube portion 65 provided in the state of being wound by the winding unit 250 has a considerably small volume in the contracted state of the expansion/contraction unit 40. Therefore, in the present example, it is possible to provide the unmanned aerial vehicle 100 which has a small influence on the flight of the unmanned aerial vehicle 100 to the destination and can discharge the contents of the container 70 to the discharge target 300 with a high accuracy.

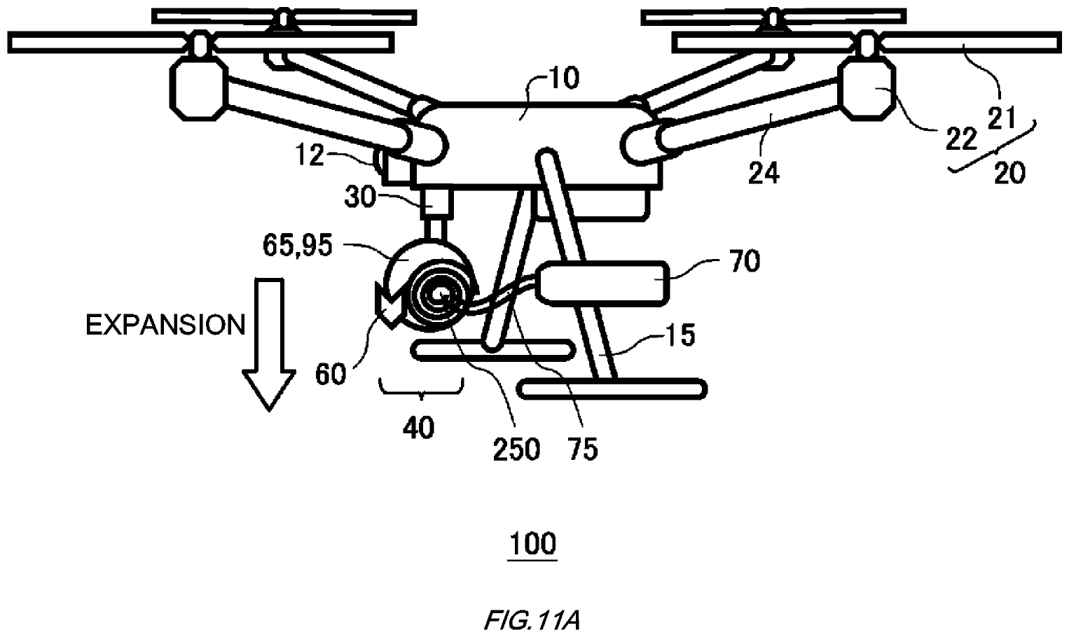

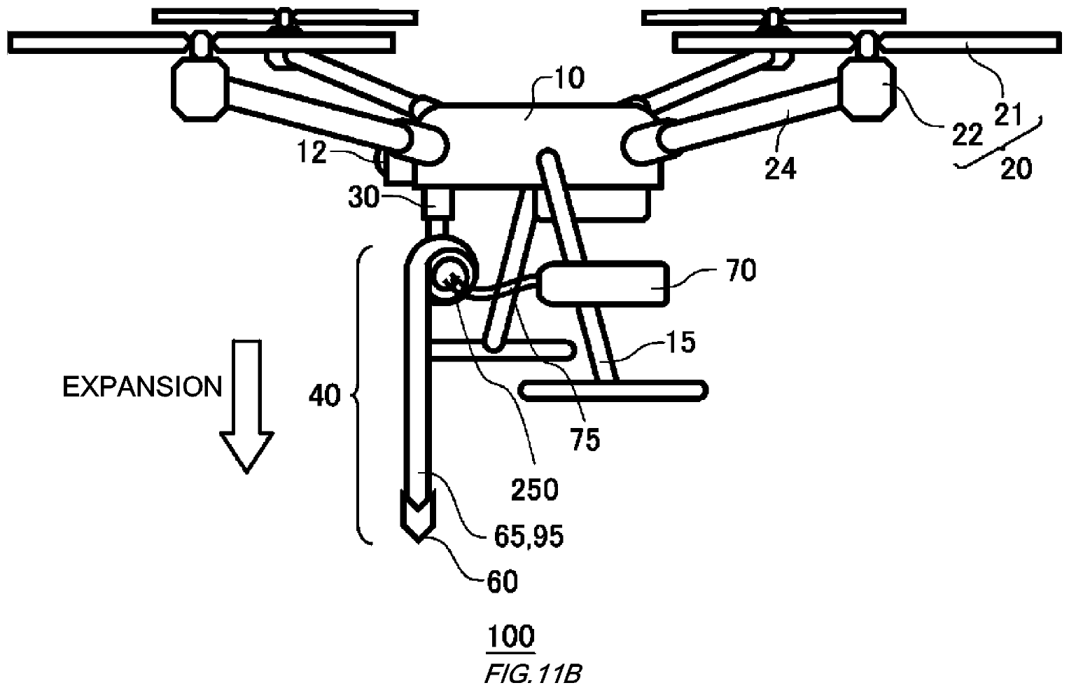

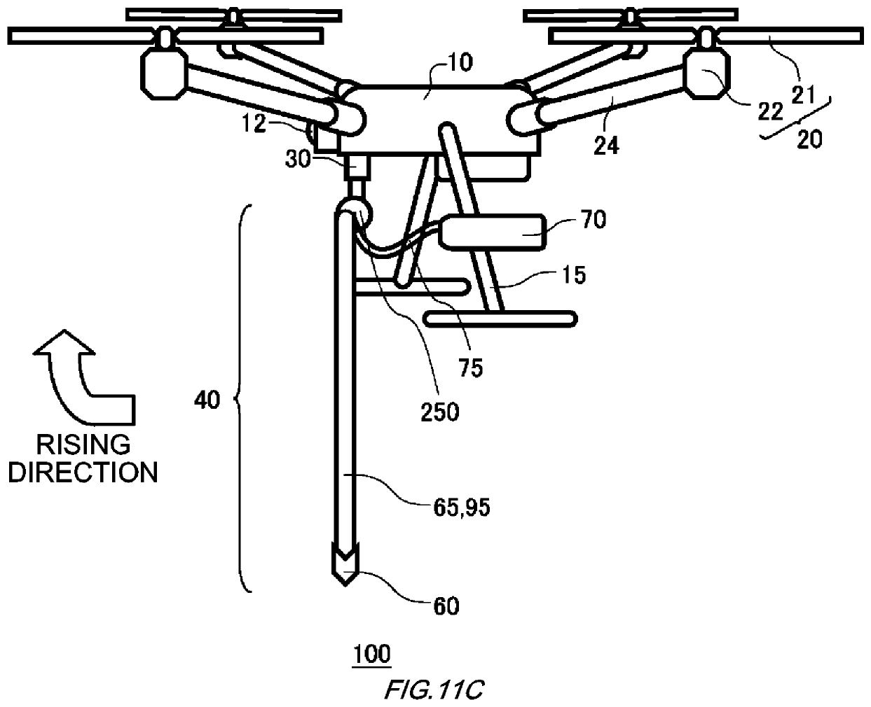

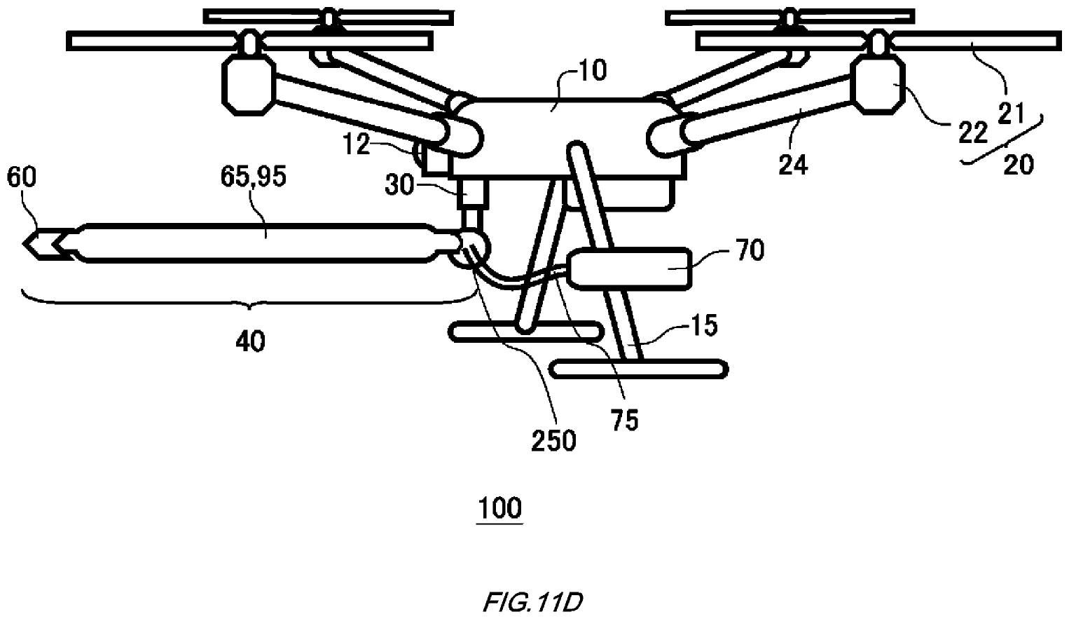

FIG. 11A illustrates another example of a side view of the unmanned aerial vehicle 100 having the winding unit 250 in a state where the expansion/contraction unit 40 is in the contracted state. Hereinafter, a difference from the example in FIG. 10A will be mainly described. In the present example, the pressure source 80 is not provided. In the present example, the balloon structure portion 95 is connected to the flow path 75 similarly to the tube portion 65. That is, the fluid injected into the balloon structure portion 95 of the present example also becomes the contents injected from the container 70.

The expansion/contraction unit 40 of the present example is also unwound and expanded by the unwinding rotation of the winding unit 250. However, the contents may be injected into the tube portion 65 and the balloon structure portion 95 in parallel with the unwinding of the tube portion 65 and the balloon structure portion 95, and the expansion of the expansion/contraction unit 40 may be performed by another mechanism in parallel with the unwinding of the winding unit 250.

FIG. 11B illustrates another example of a side view of the unmanned aerial vehicle 100 having the winding unit 250 in a state where the expansion/contraction unit 40 is in the expansion transient state. In the present example, similarly to the example in FIG. 10B, the tube portion 65 and the balloon structure portion 95 are unwound to the lower side of the unmanned aerial vehicle 100 by unwinding the winding unit 250.

FIG. 11C illustrates another example of a side view of the unmanned aerial vehicle 100 having the winding unit 250 in a state where the expansion/contraction unit 40 is in the expanded state. In the present example, similarly to the example in FIG. 10C, the expansion/contraction unit 40 is illustrated in a state where the tube portion 65 and the balloon structure portion 95 are completely unwound by the unwinding of the winding unit 250. When the contents are provided from the container 70 through the flow path 75, the balloon structure portion 95 is inflated. Also in the present example, in order to direct the entire expansion/contraction unit 40 toward the discharge target 300, the balloon structure portion 95 rises in the rising direction by the structure maintaining force caused by the internal pressure of the contents.

FIG. 11D illustrates another example of a side view of the unmanned aerial vehicle 100 having the winding unit 250 in the discharge preparation completed state of the tube portion 65. In the present example, similarly to the example in FIG. 10D, the tube portion 65 and the balloon structure portion 95 rise after complete expansion, and the discharge port 60 is directed in the direction of the discharge target 300. However, the injection of the contents into the tube portion 65 and the balloon structure portion 95 may be performed in the middle of unwinding the tube portion 65 and the balloon structure portion 95. In the present example, the inflated balloon structure portion 95 is held by the winding outlet 255, whereby the discharge port 60 is directed in the direction of the discharge target 300.

FIG. 12 illustrates an example of a side view illustrating a sensing range 78 of the distance measuring sensor 77. The sensing range 78 of the present example is a conical solid angle element, but the shape of the sensing range 78 is not limited to the conical shape, and may be a columnar shape, a spherical shape, or the like.

As an example, the distance measuring sensor 77 includes a 3D sensor system such as 3D scannable light detection and ranging (LiDAR). The distance measuring sensor 77 may be a device in which a radar, an infrared sensor, a vertical laser device, and a camera are combined, and may be implemented as a 3D camera device.

The distance measuring sensor 77 of the present example can detect the outer shape and the distance D_{T} of the discharge target 300 by one operation. Therefore, even when the distance D_{T} of the discharge target 300 having an unevenness is detected, the outer shape can be detected before the expansion/contraction unit 40 reaches the protrusion portion of the discharge target 300, and the expansion/contraction unit 40 can be contracted. As a result, it is possible to prevent the expansion/contraction unit 40 from colliding with the discharge target 300.

The sensing range 78 in the present example has a large solid angle. Therefore, the unmanned aerial vehicle 100 can detect the outer shape of the discharge target 300 in advance. Since the sensing range 78 has a wide range, when the unmanned aerial vehicle 100 moves with respect to the discharge target 300, the discharge position control unit 16 can control the expansion/contraction of the expansion/contraction unit 40 according to the outer shape of the discharge target 300.

The expansion/contraction control of the discharge position control unit 16 when the unmanned aerial vehicle 100 moves may be automatically executed. As a result, without additionally providing an operator that controls the discharge position control unit 16, the operation of uniformly discharging the contents to the discharge target 300 can be executed only by an operator that moves the unmanned aerial vehicle 100 to the vicinity of discharge target 300.

FIG. 13A illustrates an example of a side view when the unmanned aerial vehicle 100 is controlled to translate with respect to the discharge target 300 having an unevenness. The unmanned aerial vehicle 100 of the present example moves vertically upward while discharging the contents to the discharge target 300. The discharge target 300 of the present example has a protrusion 320.

The unmanned aerial vehicle 100 of the present example operates the discharge position control unit 16 to control the expansion/contraction of the expansion/contraction unit 40 with respect to the discharge target 300. As a result, the unmanned aerial vehicle 100 moves vertically upward while maintaining the distance D_{T} between the discharge target 300 and the discharge port 60 constant.

Since the sensing range 78 of the distance measuring sensor 77 has a large solid angle range, the distance measuring sensor 77 can sense the presence of the protrusion 320 in advance before the unmanned aerial vehicle 100 reaches the protrusion 320 of the discharge target 300. Therefore, even when the protrusion 320 is present, the discharge position control unit 16 can maintain the distance D_{T} between the discharge target 300 and the discharge port 60 constant. As a result, the unmanned aerial vehicle 100 can move with respect to the discharge target 300 without colliding the expansion/contraction unit 40.

FIG. 13B illustrates an example of a side view when the unmanned aerial vehicle 100 is controlled to translate with respect to the discharge target 300 having the unevenness. The unmanned aerial vehicle 100 senses the presence of the protrusion 320 in advance by the distance measuring sensor 77 before reaching the protrusion 320.

When the unmanned aerial vehicle 100 translationally moves vertically upward with respect to discharge target 300, the discharge position control unit 16 can control the expansion/contraction of the expansion/contraction unit 40 to maintain the distance D_{T} between discharge target 300 and discharge port 60 constant even when the discharge target 300 has the protrusion 320. As a result, the contents can be discharged at the distance D_{T} corresponding to physical properties such as the viscosity of the contents of the container 70.

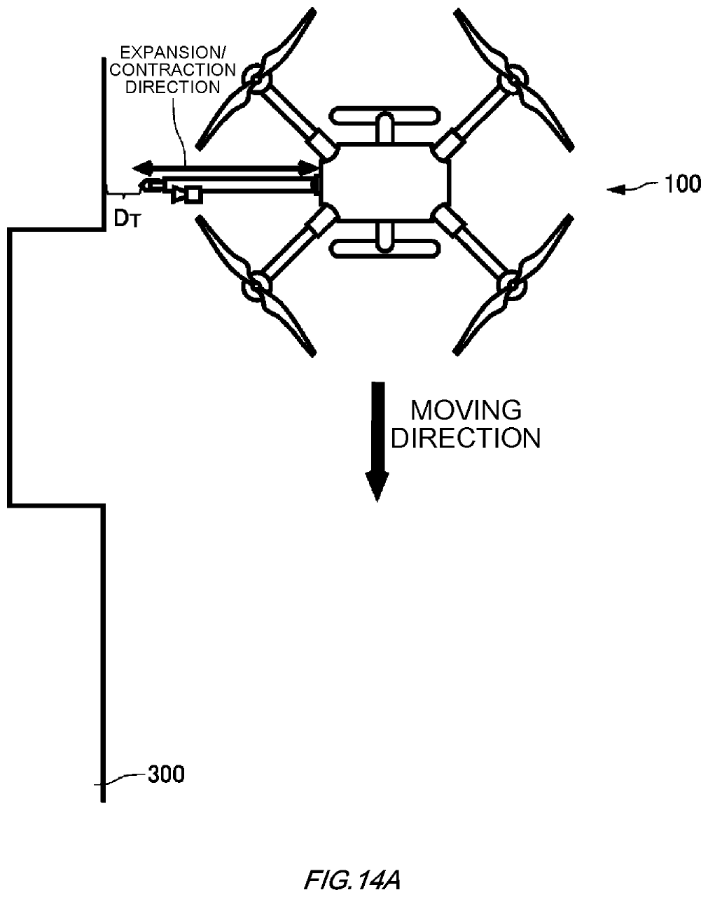

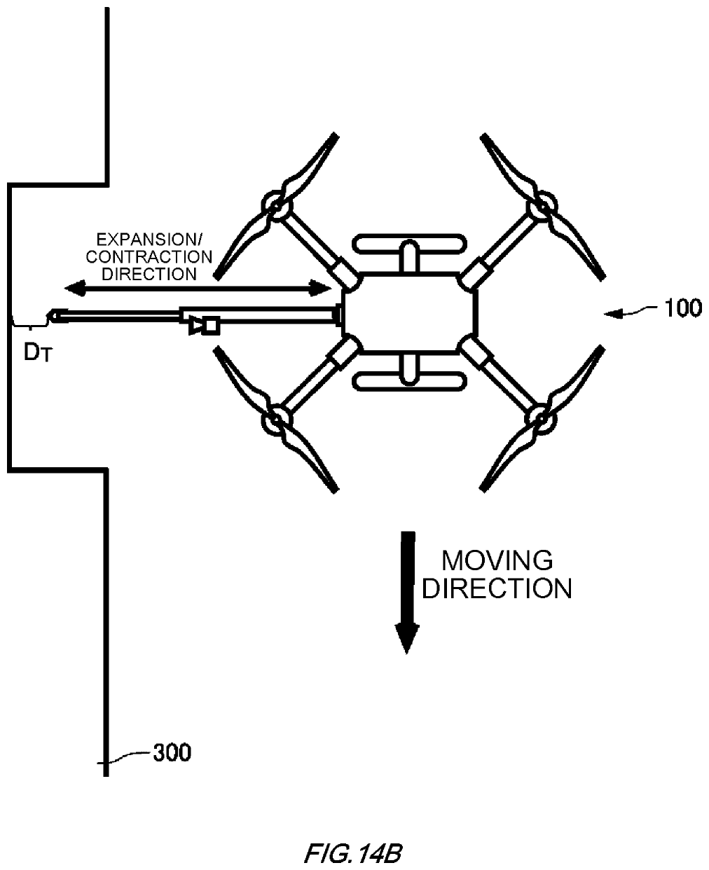

FIG. 14A illustrates an example of a top view when the unmanned aerial vehicle 100 is controlled to translate with respect to the discharge target 300 having an unevenness. The unmanned aerial vehicle 100 translationally moves in a horizontal direction with respect to the discharge target 300.

Since the distance measuring sensor 77 has the sensing range 78 having a large solid angle, the outer shape of the discharge target 300 can be sensed in a wide range. When the unmanned aerial vehicle 100 translationally moves with respect to the discharge target 300, the distance measuring sensor 77 can sense in advance the outer shape of the discharge target 300 which is the movement destination of the unmanned aerial vehicle 100.

The discharge position control unit 16 may control the expansion/contraction of the expansion/contraction unit 40 on the basis of the detection result of the distance measuring sensor 77. As a result, the distance D_{T} between the discharge target 300 and the discharge port 60 can be maintained constant.

FIG. 14B illustrates an example of a top view when the unmanned aerial vehicle 100 is controlled to translate with respect to the discharge target 300 having the unevenness. In the present example, the unmanned aerial vehicle 100 opposes the concave portion of the discharge target 300.

Also in the present example, by expanding the expansion/contraction unit 40, the distance D_{T} between the discharge target 300 and the discharge port 60 is equal to that in the example of FIG. 14A. The discharge position control unit 16 can perform the expansion/contraction control according to the outer shape of the discharge target 300 on the basis of the distance measurement data acquired by the acquisition unit 14 from the distance measuring sensor 77.

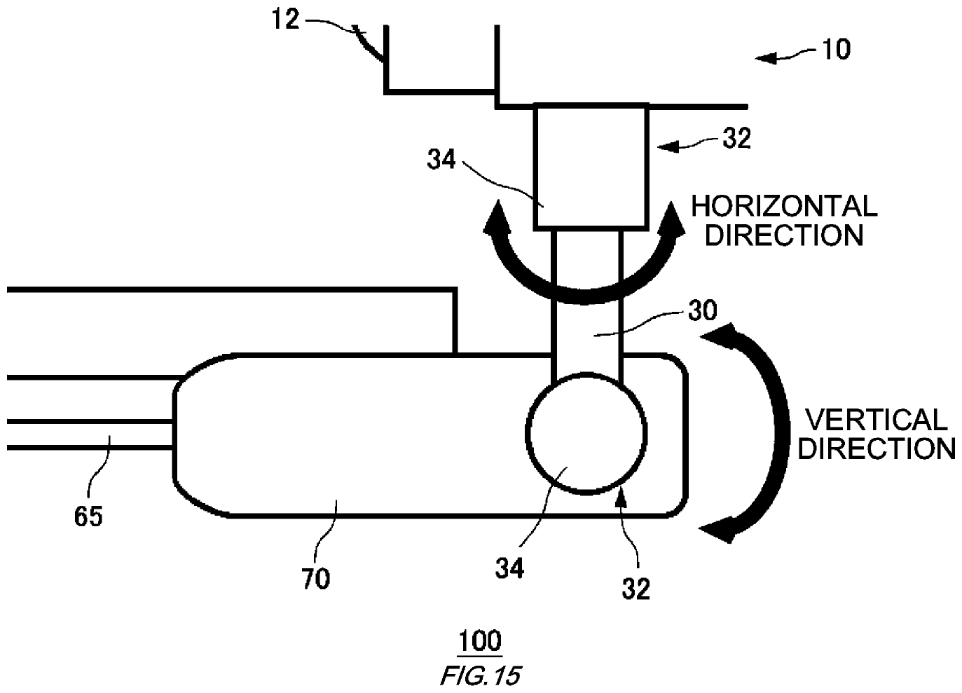

FIG. 15 illustrates an example of an enlarged view of the vicinity of the container 70 and the support portion 30. The unmanned aerial vehicle 100 may include a rotation mechanism 32 and a rotary connection portion 34. The present example corresponds to the enlarged view illustrating region A in FIG. 1C.

The rotary connection portion 34 connects the expansion/contraction unit 40 to the main body 10 of the unmanned aerial vehicle 100. The rotary connection portion 34 may be provided in the support portion 30. The rotary connection portion 34 of the present example connects the expansion/contraction unit 40 to the main body 10 via the support portion 30. As an example, the rotary connection portion 34 includes a joint, a bearing, or the like, and rotatably connects the container 70 or the expansion/contraction unit 40 to the main body 10.

In the present example, two rotary connection portions 34 are provided. A rotation can be performed in a horizontal direction with reference to a direction in which the imaging device 12 of the main body 10 provided between the main body 10 and the support portion 30 is provided, that is, a yawing direction. On the other hand, the rotary connection portion 34 provided between the support portion 30 and the container 70 enables rotation in a vertical direction with respect to the direction in which the imaging device 12 is provided, that is, a pitching direction. The unmanned aerial vehicle 100 can adjust the angle of the expansion/contraction unit 40 and the discharge port 60 with respect to the discharge target 300 by adjusting the angles of the rotary connection portions 34.

The rotation mechanism 32 can control the angle of the discharge port 60 with respect to the discharge target 300 to which the contents of the container 70 are discharged. The rotation mechanism 32 may be an actuator, a motor, or the like. The rotation mechanism 32 controls the angle of the discharge port 60 by rotationally driving the rotary connection portion 34.

The discharge position control unit 16 may operate the rotation mechanism 32 on the basis of the acquisition result of the flight information, the control information, and the like from the acquisition unit 14. As a result, the angle of the discharge port 60 can be controlled on the basis of the acquisition result of the acquisition unit 14. Therefore, the contents can be discharged to the discharge target 300 according to the physical properties of the contents and the acquisition result of the acquisition unit 14.

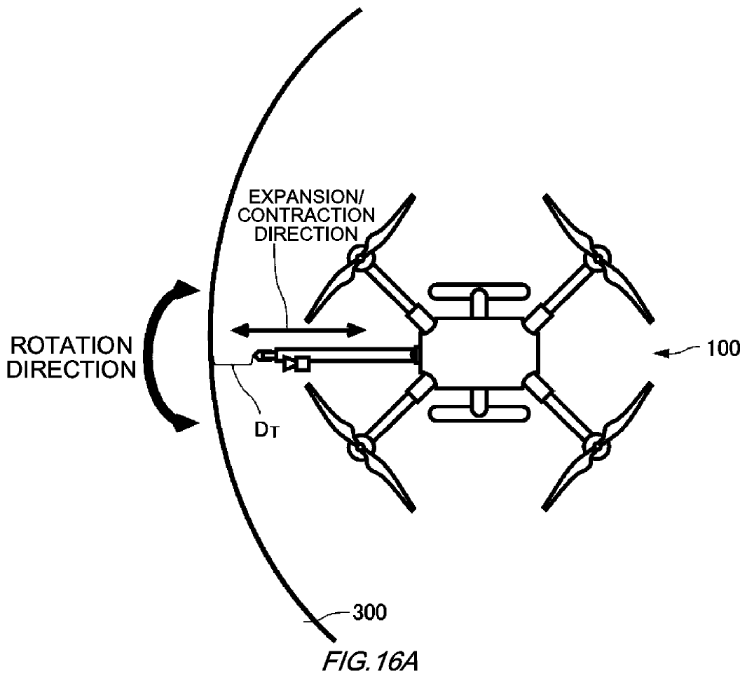

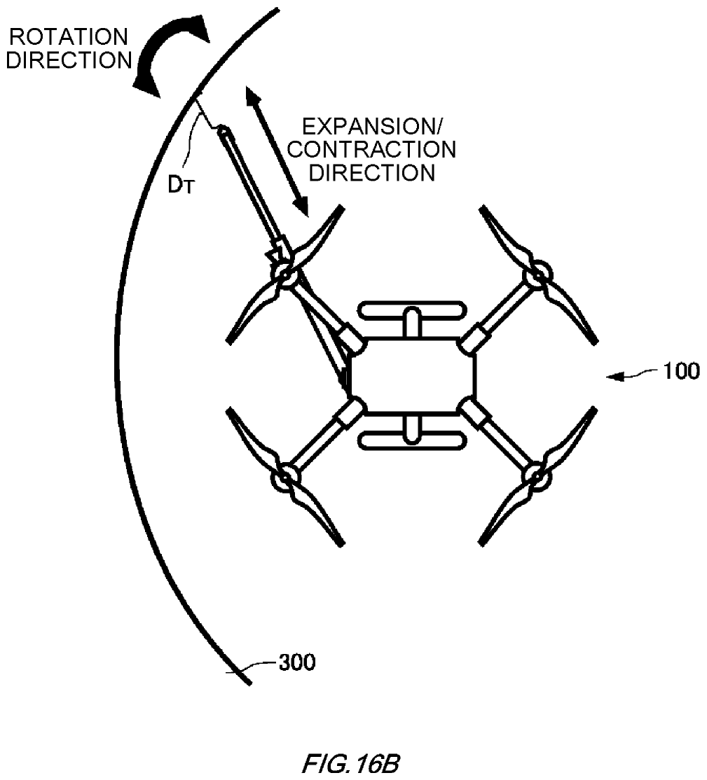

FIG. 16A illustrates an example of a top view when the expansion/contraction unit 40 is controlled to rotate with respect to the discharge target 300 having a curved surface shape. The discharge target 300 of the present example has a surface which opposes the discharge port 60 of the unmanned aerial vehicle 100 and has a concave shape. For example, the discharge target 300 of the present example may be a curved surface having a concave shape of a quadratic curve such as a parabolic antenna.

The unmanned aerial vehicle 100 of the present example is positioned at a position deviated from the center of curvature of the concave shape of the discharge target 300. In the present example, the expansion/contraction unit 40 is rotationally moved along the discharge target 300 without moving the unmanned aerial vehicle 100 itself. However, a relative angle between the extending direction of the expansion/contraction unit 40 and the discharge target 300 may be similarly changed by rotating the unmanned aerial vehicle 100 itself.

When the position of the unmanned aerial vehicle 100 is positioned at a position away from the center of curvature of the discharge target 300, the relative distance D_{T} between the main body 10 of the unmanned aerial vehicle 100 and the discharge target 300 changes according to the angle to which the expansion/contraction unit 40 is rotated. Even when the expansion/contraction unit 40 is rotated, the discharge position control unit 16 can control the expansion/contraction of the expansion/contraction unit 40 in order to keep the distance D_{T} between the discharge port 60 and the discharge target 300 constant. As a result, the unmanned aerial vehicle 100 can discharge the contents at a distance which is determined according to the physical properties of the contents of the container 70 and is suitable for discharge.

FIG. 16B illustrates an example of a top view when the expansion/contraction unit 40 is controlled to rotate with respect to the discharge target 300 having the curved surface shape. In the present example, a difference from the example in FIG. 16A will be mainly described.

In the present example, by rotating the expansion/contraction unit 40, the angle of the discharge port 60 is directed to an angle different from that in the example in FIG. 16A. On the other hand, the distance D_{T} is kept constant by expanding the expansion/contraction unit 40 from the example in FIG. 16A.

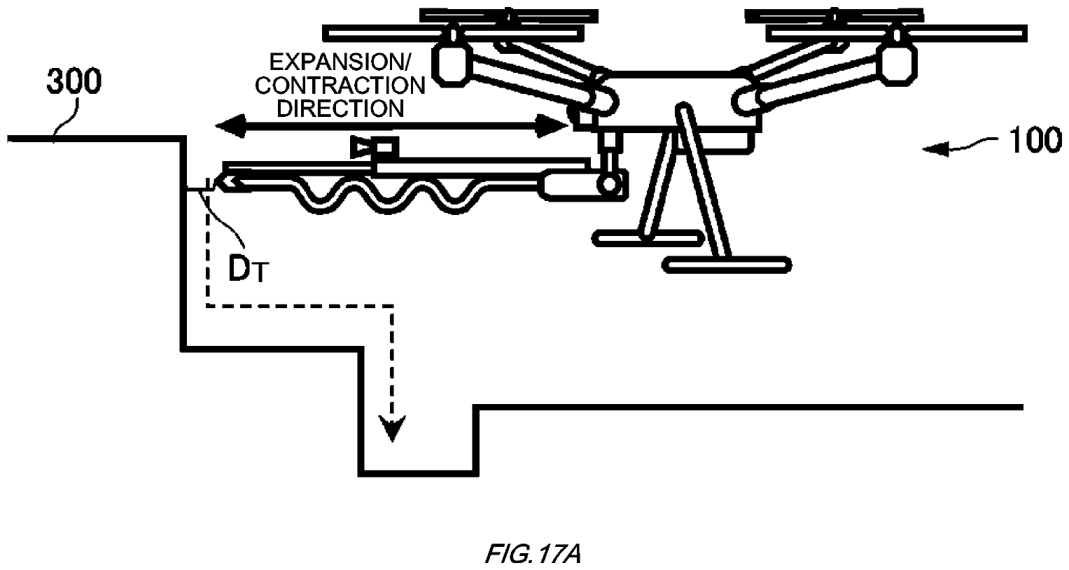

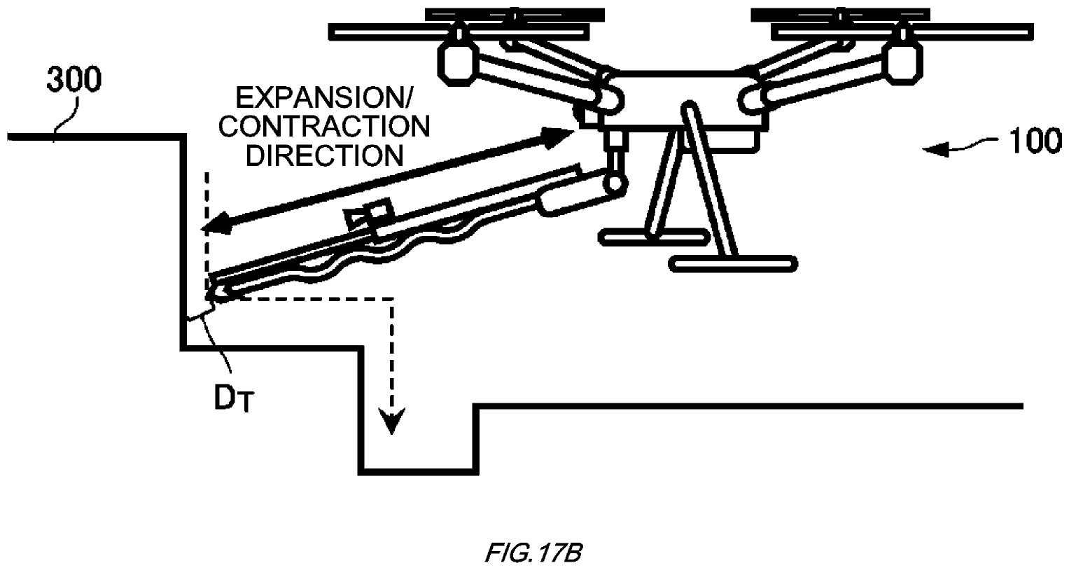

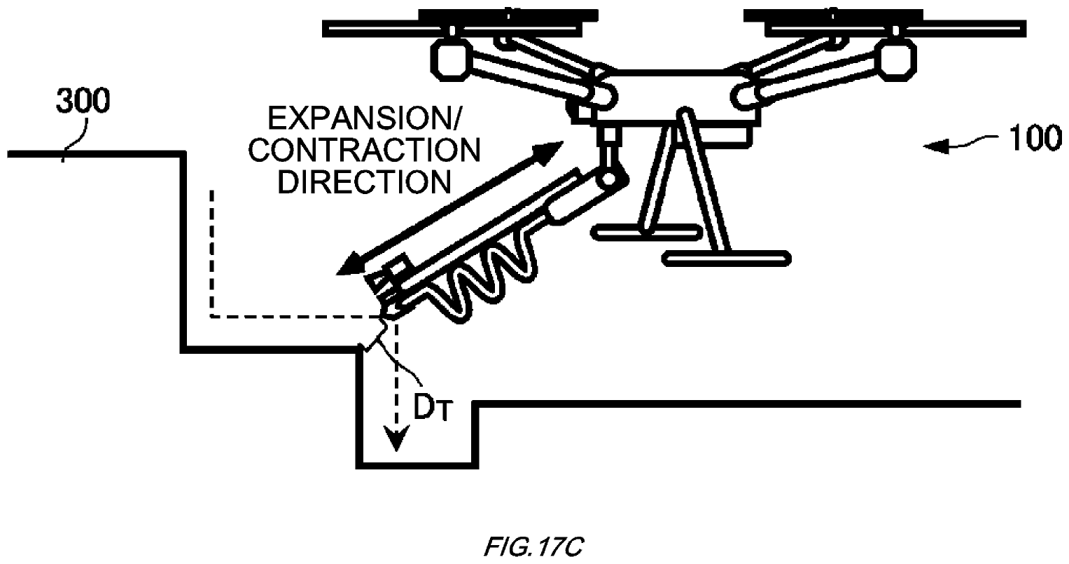

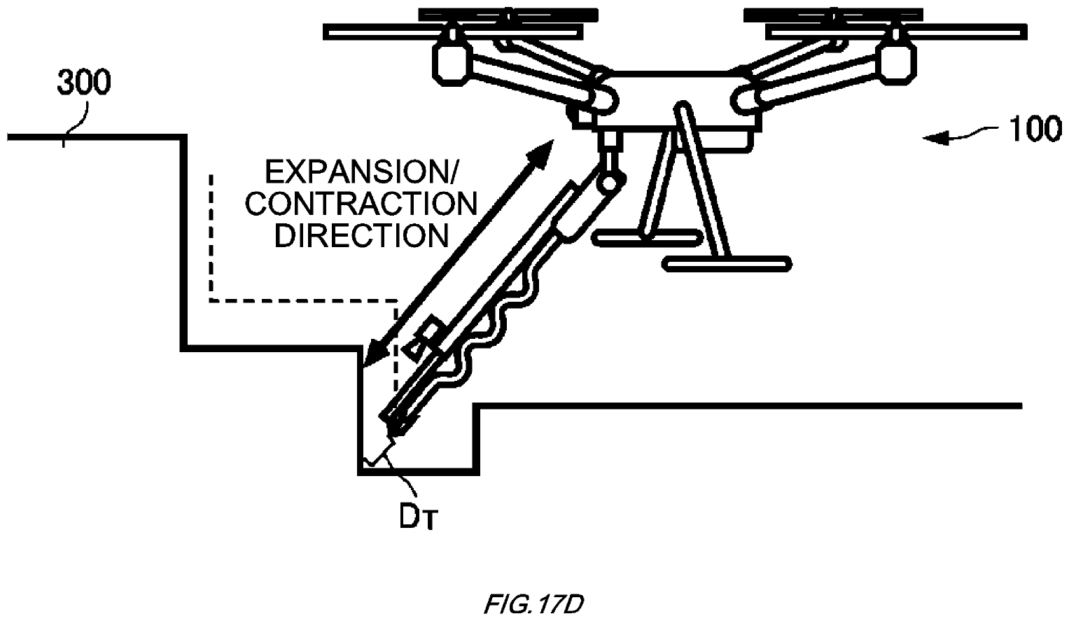

FIG. 17A illustrates an example of a side view when the expansion/contraction unit 40 is controlled to rotate with respect to the discharge target 300 having an unevenness. In the present example, the discharge target 300 has a stepped shape.

In the present example, while the position of the unmanned aerial vehicle 100 with respect to the discharge target 300 is kept constant, the expansion/contraction unit 40 is rotationally moved in the vertical direction with respect to the direction in which the imaging device 12 is provided, that is, in the pitching direction. The acquisition unit 14 acquires information regarding the outer shape of the discharge target 300 from the distance measuring sensor 77. The discharge position control unit 16 rotationally controls the angle of the expansion/contraction unit 40 and controls the expansion/contraction of the expansion/contraction unit 40 on the basis of the acquisition result of the acquisition unit 14. Furthermore, by moving the expansion/contraction unit 40 following the discharge target 300, the state ahead of the discharge port 60 can be finely observed via the distance measuring sensor 77.

As a result, the unmanned aerial vehicle 100 can move the discharge port 60 to follow the outer shape of the discharge target 300 without moving the position of the main body 10. Therefore, the distance D_{T} of the discharge port 60 with respect to the discharge target 300 can be kept constant, and the discharge condition of the contents to the discharge target 300 can be maintained.

FIG. 17B illustrates an example of a side view when the expansion/contraction unit 40 is controlled to rotate with respect to the discharge target 300 having the unevenness. In the present example, the discharge port 60 is moved vertically downward from the side view of FIG. 17A.

When the angle of the discharge port 60 is rotationally moved downward while maintaining the position of the main body 10, the discharge port 60 rotates while drawing a circle around the main body 10 unless the length of the expansion/contraction unit 40 is changed. Therefore, when the discharge port 60 is moved vertically downward to follow the outer shape of the discharge target 300, the discharge position control unit 16 performs a control to expand the expansion/contraction unit 40.

FIG. 17C illustrates an example of a side view when the expansion/contraction unit 40 is controlled to rotate with respect to the discharge target 300 having the unevenness. In the present example, the discharge port 60 moves toward the main body 10 in the horizontal direction from the side view of FIG. 17B.

When the angle of the discharge port 60 is rotationally moved downward while maintaining the position of the main body 10, the discharge port 60 rotates while drawing a circle around the main body 10 unless the length of the expansion/contraction unit 40 is changed. Therefore, when the discharge port 60 is moved toward the main body 10 in the horizontal direction to follow the outer shape of the discharge target 300, the discharge position control unit 16 performs a control to contract the expansion/contraction unit 40.

FIG. 17D illustrates an example of a side view when the expansion/contraction unit 40 is controlled to rotate with respect to the discharge target 300 having the unevenness. In the present example, the discharge port 60 is moved vertically downward from the side view of FIG. 17C.

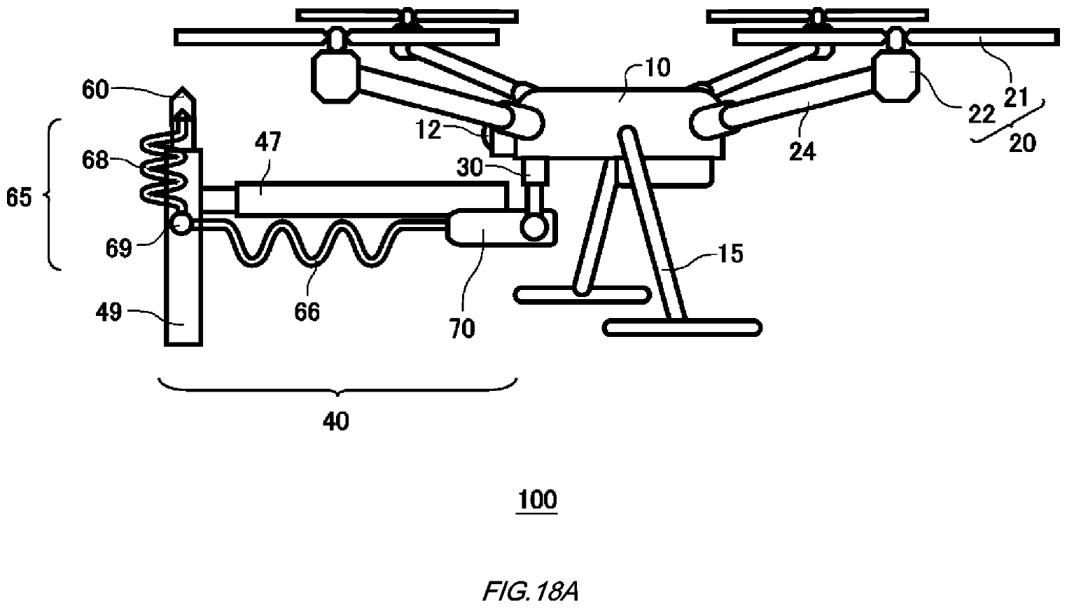

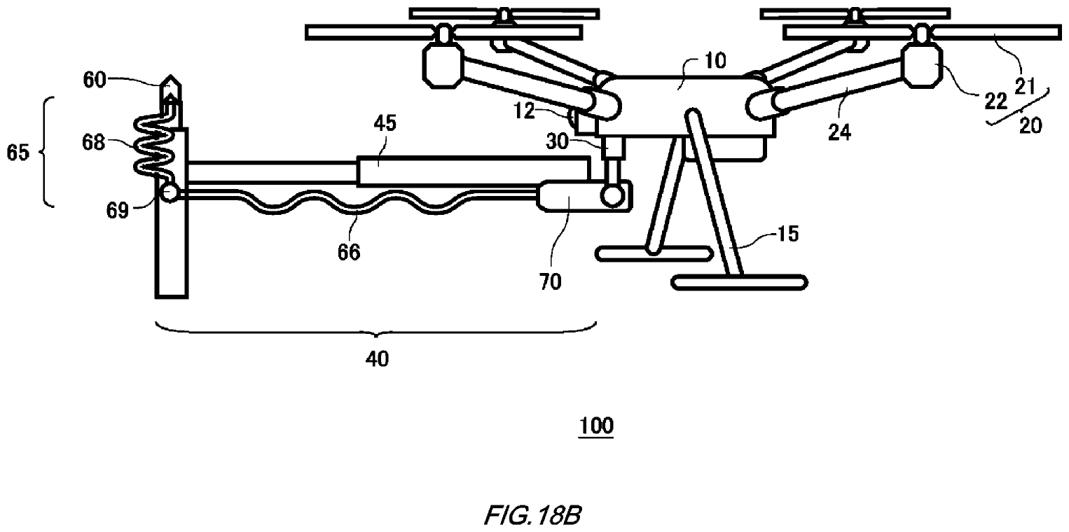

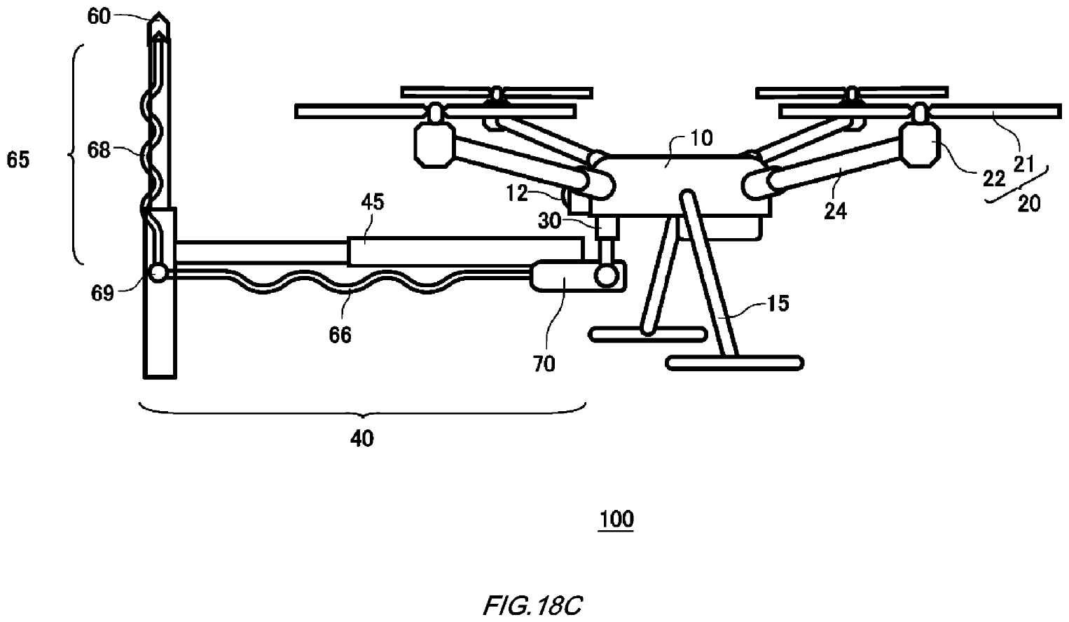

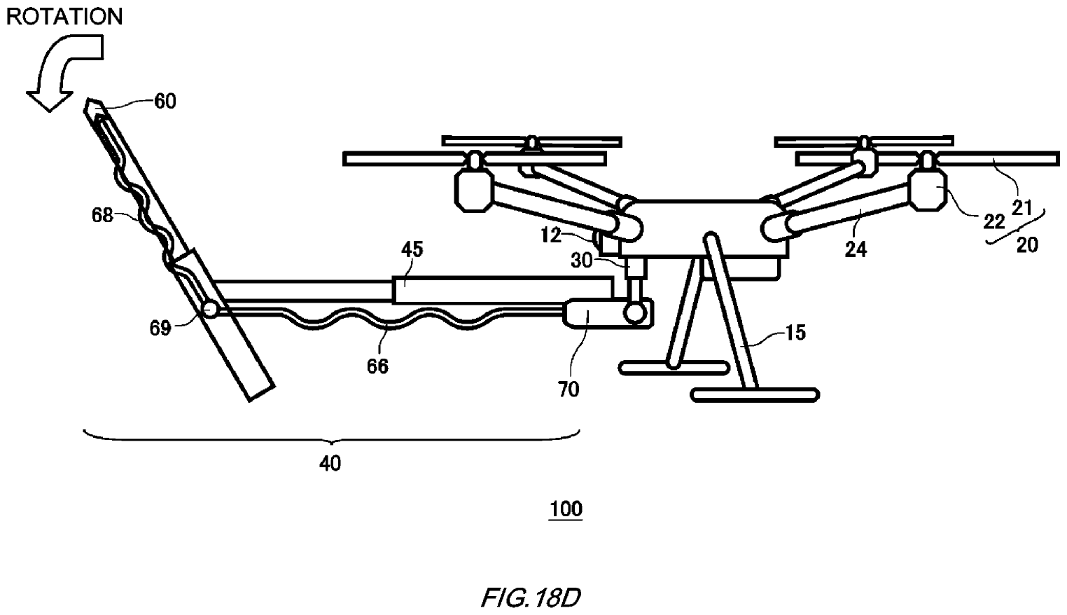

FIG. 18A illustrates an example of a side view of the unmanned aerial vehicle 100 having the expansion/contraction unit 40 which expands/contracts in two stages in a state where expansion/contraction unit 40 is in the contracted state. The expansion/contraction unit 40 of the present example includes a first extending portion 66, a second extending portion 68 provided on the distal end side of the expansion/contraction unit 40 with respect to the first extending portion 66, and a bent portion 69 bendably connecting the first extending portion 66 and the second extending portion 68.

The rotation mechanism 32 may be provided side by side with the bent portion 69. The angle of the bent portion 69 may be adjusted by the operation of the rotation mechanism 32. In the present example, the bent portion 69 functions as the rotary connection portion 34. That is, the rotation mechanism 32 may be provided in the middle of the expansion/contraction unit 40 instead of being provided in the support portion 30.

In this case, the rotation mechanism 32 can control the angles of the second extending portion 68 and the expansion/contraction unit 40 by rotationally driving the rotary connection portion 34. As a result, the rotation mechanism 32 may control the angle of the discharge port 60 by controlling the angle of the expansion/contraction unit 40.

The expansion/contraction unit 40 of the present example is provided with a first expansion/contraction mechanism 47 provided in parallel with the first extending portion 66 and a second expansion/contraction mechanism 49 provided in parallel with the second extending portion 68. When the first expansion/contraction mechanism 47 operates, the first extending portion 66 expands/contracts, and when the second expansion/contraction mechanism 49 operates, the second extending portion 68 expands/contracts.

In the expansion/contraction unit 40 of the present example, the second extending portion 68 operates after the first extending portion 66 extends. However, the order of operations of the first extending portion 66 and the second extending portion 68 is not limited to this order. In another example, the second extending portion 68 may be operated before the first extending portion 66, and the second extending portion 68 may be operated in the middle of the operation of the first extending portion 66.

FIG. 18B illustrates an example of a side view of the unmanned aerial vehicle 100 having the expansion/contraction unit 40 which expands/contracts in two stages in a state where the first extending portion 66 expands. In the present example, by expanding the first extending portion 66, it is possible to direct the discharge port 60 for the object separated from the central portion of the unmanned aerial vehicle 100 in the radial direction when the unmanned aerial vehicle 100 is viewed from above. As a result, it becomes easier to aim the discharge target 300 positioned at a position away from the unmanned aerial vehicle 100.

FIG. 18C illustrates an example of a side view of the unmanned aerial vehicle 100 having the expansion/contraction unit 40 that expands/contracts in two stages in a state where the first extending portion 66 expands. In the present example, the angle of the second extending portion 68 varies when the second extending portion 68 expands and the bent portion 69 rotates. As a result, it becomes easy to discharge the contents to the discharge target 300 obliquely above or obliquely below the unmanned aerial vehicle 100.

FIG. 18D illustrates an example of a side view of the unmanned aerial vehicle 100 having the expansion/contraction unit 40 which expands/contracts in two stages in a state where the expansion/contraction unit 40 is rotated. In the present example, the discharge port 60 provided at the distal end of the second extending portion 68 is directed obliquely upward. As a result, it becomes easier to aim the discharge target 300 obliquely above the unmanned aerial vehicle 100.

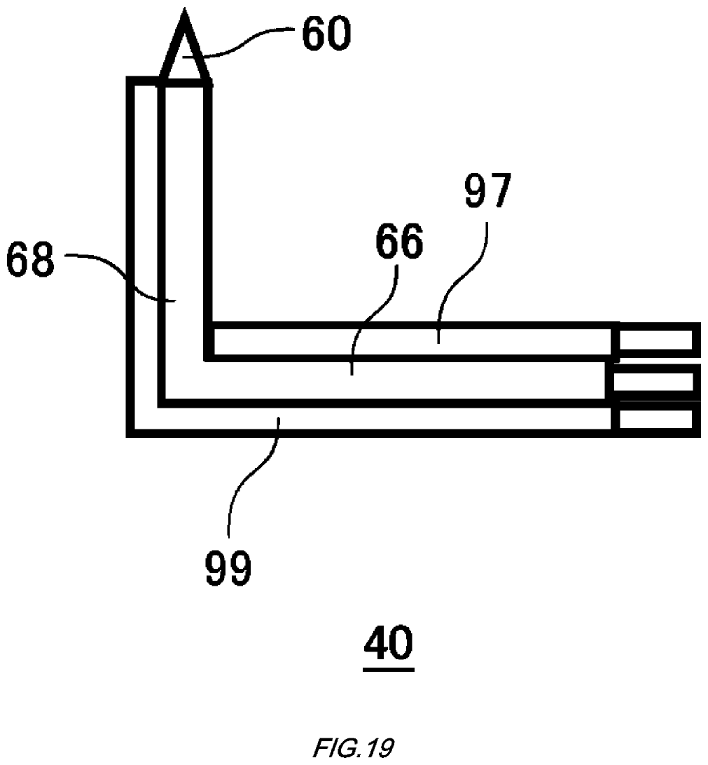

FIG. 19 illustrates an example of the expansion/contraction unit 40 which expands/contracts in two stages. In the expansion/contraction unit 40 of the present example, the first balloon structure portion 97 is provided in parallel with the first extending portion 66. Further, the second balloon structure portion 99 is provided in parallel with the first extending portion 66 and the second extending portion 68.

The second extending portion 68 is provided to be inclined at a predetermined angle with respect to the first extending portion 66. The second extending portion 68 of the present example is directed in a direction perpendicular to the first extending portion 66. The expansion/contraction unit 40 may have a detachable structure. The expansion/contraction unit 40 is replaced with the expansion/contraction unit having the second extending portion 68 having a different inclination angle with respect to the discharge target 300 at a desired angle. The expansion/contraction unit 40 of the present example provides a structure in which the contents can be easily discharged to the discharge target 300 provided above.

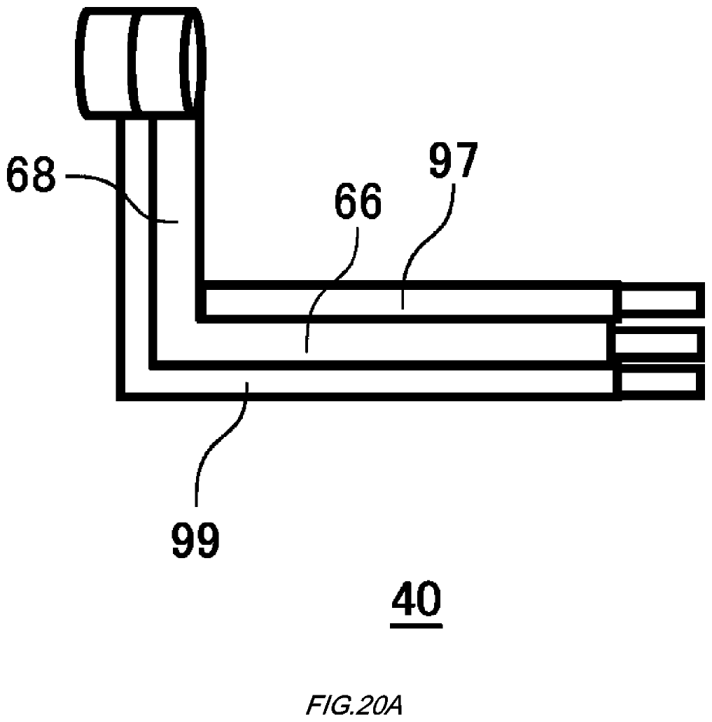

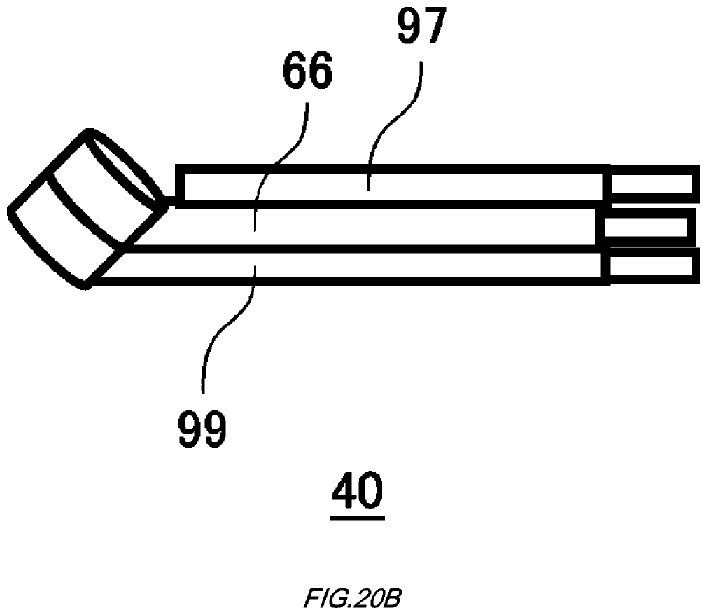

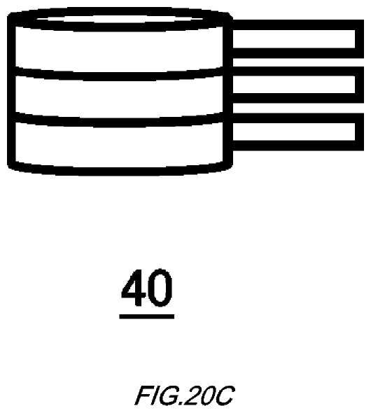

FIG. 20A illustrates an example of the expansion/contraction unit 40 which expands/contracts in two stages in a state where the expansion/contraction unit 40 is in a contraction transient state. The present example illustrates an example in which the expansion/contraction unit 40 illustrated in FIG. 19 is in the contraction transient state.

The second balloon structure portion 99, the first extending portion 66, and the second extending portion 68 may be provided with a material having an elasticity. The elastic material of the second balloon structure portion 99, the first extending portion 66, and the second extending portion 68 of the present example has a structure rounded in a predetermined direction in a steady state. Therefore, when the fluid flows out from the first balloon structure portion 97 and the second balloon structure portion 99, the expansion/contraction unit 40 of the present example contracts to be rounded in the predetermined direction.

FIG. 20B illustrates an example of the expansion/contraction unit 40 which expands/contracts in two stages in a contraction transient state in which the first extending portion 66 expands. In the present example, when the fluid flows out from the second balloon structure portion 99 and the second extending portion 68, the second extending portion 68 is rounded in a predetermined direction. The first extending portion 66 and the second extending portion 68 may be provided with a material having a sufficient flexibility so that a boundary portion between the first extending portion 66 and the second extending portion 68 is not damaged at the time of contraction. Furthermore, by allowing the fluid to flow out from the first balloon structure portion 97, the first extending portion 66 also contracts.

FIG. 20C illustrates an example of the expansion/contraction unit 40 which expands/contracts in two stages in a state where the expansion/contraction unit 40 is in a contracted state. In the present example, the fluid is flowing out from both the first balloon structure portion 97 and the second balloon structure portion 99.

In the present example, the contraction to be rounded in the predetermined direction is performed by the elasticity of the first balloon structure portion 97 and the second balloon structure portion 99, or the first extending portion 66 and the second extending portion 68. As a result, the volume occupied by the expansion/contraction unit 40 in the contracted state decreases. Therefore, a risk that the expansion/contraction unit 40 is caught by a surrounding object during the flight of the unmanned aerial vehicle 100 is reduced.

In the present example, an example has been described in which the expansion/contraction unit 40 which expands/contracts in two stages is contracted. Contrary to the present example, by providing fluid to the first balloon structure portion 97 and then providing fluid to the second balloon structure portion 99 in sequence, the first extending portion 66 and the second extending portion 68 rise in sequence to an L-shape.

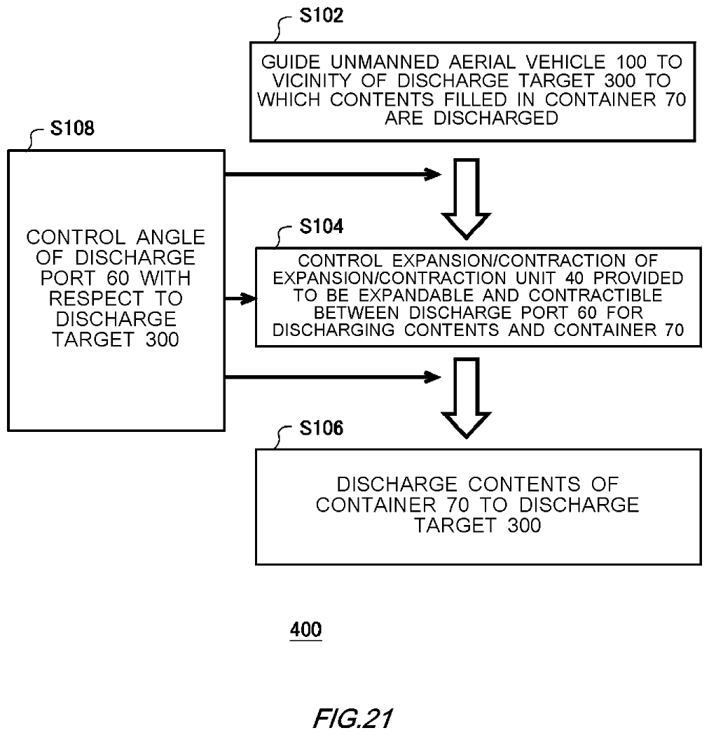

FIG. 21 illustrates an example of a flow diagram of a control method 400 of the unmanned aerial vehicle 100. The control method 400 includes steps S102 to S106, and may further include step S108.

In step S102, the unmanned aerial vehicle 100 is guided to the vicinity of the discharge target 300 to which the contents filled in the container 70 are discharged. The guidance of the unmanned aerial vehicle 100 to the discharge target 300 may be performed on the basis of the flight information set in advance, or may performed on the basis of the flight information acquired by the acquisition unit 14 through communication or the like.

In step S104, the expansion/contraction of the expansion/contraction unit 40 provided to be expandable/contractible between the discharge port 60 for the contents and the container 70 is controlled. By performing the expansion/contraction control, the contents can be discharged to the discharge target 300 at a distance suitable for the contents. In step S106, the contents filled in the container of the unmanned aerial vehicle 100 are discharged to the discharge target 300.

In paragraph S108, the angle of the discharge port 60 with respect to the discharge target 300 is controlled. The unmanned aerial vehicle 100 may adjust the angle of the discharge port 60 by driving the rotation mechanism 32. Step S108 may be performed before step S106 of discharging the contents to the discharge target. Step S108 may be performed before step S104, may be performed with step S104, or may be performed after step S104.

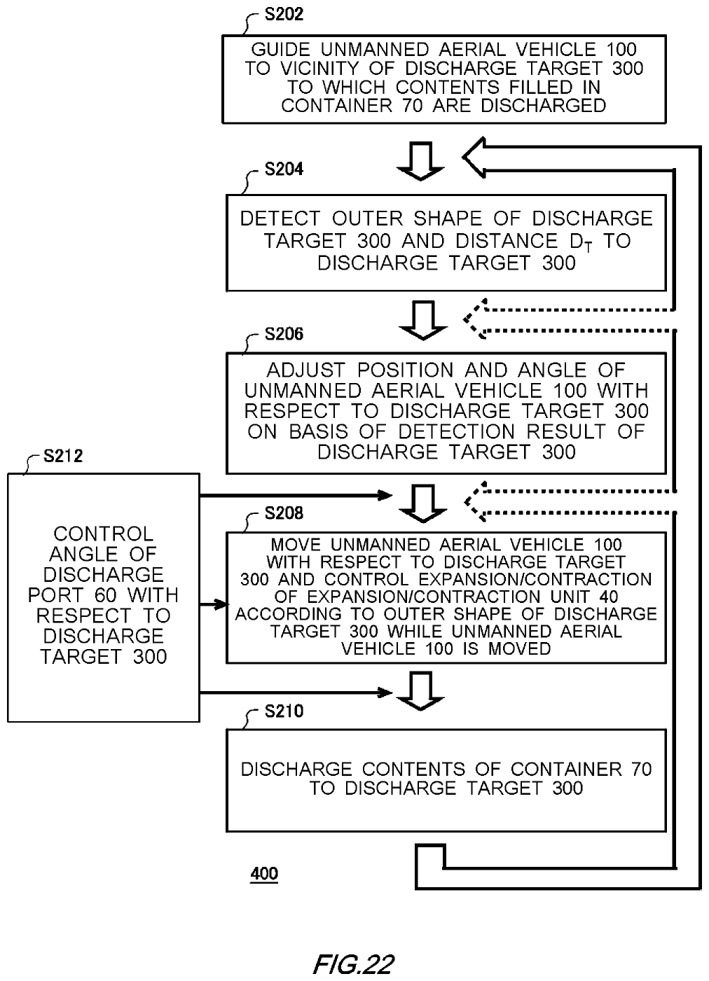

FIG. 22 illustrates another example of a flow diagram of the control method 400 of the unmanned aerial vehicle 100. The control method 400 includes steps S202 to S210, and may further include step S212.

In step S202, the unmanned aerial vehicle 100 is guided to the vicinity of the discharge target 300 to which the contents filled in the container 70 are discharged. The guidance of the unmanned aerial vehicle 100 to the discharge target 300 may be performed on the basis of the flight information set in advance, or may be performed on the basis of the flight information acquired by the acquisition unit 14 communicating with a GPS satellite, an external server, or the like.

In step S204, the outer shape of the discharge target 300 and the distance D_{T} from the unmanned aerial vehicle 100 to the discharge target 300 are detected. Step S204 may be performed after step S202 of guiding and before step S208 of the expansion/contraction control.

In step S206, the position and the angle of the unmanned aerial vehicle 100 with respect to the discharge target 300 are adjusted on the basis of the detection result of the discharge target 300. Even when the contents are discharged to a range exceeding the controllable range of the rotation control or the expansion/contraction control of the expansion/contraction unit 40, the contents can be discharged to the discharge target 300 under a condition suitable for the physical properties of the contents by adjusting the position and the angle of the unmanned aerial vehicle 100 itself.

In step S208, the unmanned aerial vehicle 100 is moved with respect to the discharge target 300, and the contents are discharged to the discharge target 300 while the unmanned aerial vehicle 100 is moved. As an example, the moving direction of the unmanned aerial vehicle 100 is a predetermined direction with respect to the discharge target 300. The unmanned aerial vehicle 100 may translationally move in a predetermined direction with respect to the discharge target 300 or may rotationally move in a predetermined direction. However, the moving direction of the unmanned aerial vehicle 100 may be based on the outer shape of the discharge target 300, the distance D_{T} to the discharge target 300, and the like. For example, the unmanned aerial vehicle 100 may move in a direction corresponding to the outer shape of the discharge target 300 to keep a constant distance with respect to the discharge target 300 on the basis of the detection result of the discharge target 300 by the shape detection unit 28.

In step S210, the unmanned aerial vehicle 100 discharges the contents of the container 70 to the discharge target 300. After performing step S210, the procedure may return back to step S204, may return back to step S206, or may return back to step S208. That is, the control method 400 can uniformly discharge the contents to the discharge target 300 according to the outer shape of the discharge target 300 by repeating the loop of steps S204 to S210.

In step S212, the unmanned aerial vehicle 100 controls the angle of the discharge port 60 with respect to the discharge target 300. The unmanned aerial vehicle 100 may adjust the angle of the discharge port 60 by driving the rotation mechanism 32. Step S212 may be performed before step S210 of discharging the contents to the discharge target. Step S212 may be performed before step S208, may be performed with step S208, or may be performed after step S208.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: main body, 12: imaging device, 14: acquisition unit, 15: leg portion, 16: discharge position control unit, 20: propulsion unit, 21: rotary blade, 22: rotary drive device, 24: arm portion, 26: attitude detection unit, 28: shape detection unit, 30: support portion, 32: rotation mechanism, 34: rotary connection portion, 40: expansion/contraction unit, 45: expansion/contraction mechanism, 47: first expansion/contraction mechanism, 49: second expansion/contraction mechanism, 60: discharge port, 65: tube portion, 66: first extending portion, 68: second extending portion, 69: bent portion, 70: container, 75: flow path, 77: distance measuring sensor, 78: sensing range, 80: pressure source, 85: pressure supply path, 90: pressure supply unit, 95: balloon structure portion, 97: first balloon structure portion, 99: second balloon structure portion, 100: unmanned aerial vehicle, 140: housing, 142: rotation portion, 144: linking portion, 146: rod fixing portion, 147: clamp, 148: shaft pin, 150: rod portion, 170: drive portion, 172: pressure supply port, 174: region, 210: elastic body, 250: winding unit, 252: rotary joint, 255: winding outlet, 260: hollow motor, 300: discharge target, 320: protrusion, 400: control method

1. An unmanned aerial vehicle comprising:
a discharge port configured to discharge contents in a container;
an expansion/contraction unit configured to connect the discharge port and the container and be expandable; and
a discharge position control unit configured to control expansion/contraction of the expansion/contraction unit.

2. The unmanned aerial vehicle according to claim 1, further comprising:
an acquisition unit configured to acquire flight information and control information of the unmanned aerial vehicle, wherein
the discharge position control unit is configured to control the expansion/contraction on a basis of an acquisition result of the acquisition unit.

3. The unmanned aerial vehicle according to claim 2, wherein the acquisition unit includes an attitude detection unit for detecting an attitude during flight.

4. The unmanned aerial vehicle according to claim 2, wherein the acquisition unit includes a shape detection unit configured to detect a shape of a discharge target to which the contents are discharged.

5. The unmanned aerial vehicle according to claim 4, further comprising: a distance measuring sensor provided side by side with the discharge port and configured to measure a distance to the discharge target, wherein
the acquisition unit is configured to acquire a measurement result from the distance measuring sensor.

6. The unmanned aerial vehicle according to claim 2, further comprising: a rotation mechanism configured to be capable of controlling an angle of the discharge port with respect to a discharge target to which the contents are discharged, wherein
the discharge position control unit is configured to control the angle of the discharge port by operating the rotation mechanism on a basis of the acquisition result.

7. The unmanned aerial vehicle according to claim 6, further comprising: a rotary connection portion configured to connect the expansion/contraction unit to a main body of the unmanned aerial vehicle, wherein
the rotation mechanism is configured to control the angle of the expansion/contraction unit by rotationally driving the rotary connection portion.

8. The unmanned aerial vehicle according to claim 1, wherein the expansion/contraction unit includes:
a first extending portion;
a second extending portion provided on a distal end side of the expansion/contraction unit with respect to the first extending portion; and
a bent portion configured to bendably connect the first extending portion and the second extending portion.

9. The unmanned aerial vehicle according to claim 1, wherein the expansion/contraction unit includes a balloon structure portion configured to be inflated when an internal pressure increases and expands when the balloon structure portion is inflated.

10. The unmanned aerial vehicle according to claim 1, wherein
the expansion/contraction unit includes a piston cylinder configured to expand/contract due to variation in an internal pressure, and
the piston cylinder includes
a housing;
a rod portion provided to at least partially protrude from the housing; and
a drive portion provided at an end of the rod portion inside the housing, the drive portion configured to move due to an air pressure difference inside the housing to vary a length of the rod portion protruding from the housing.

11. The unmanned aerial vehicle according to claim 1, wherein the expansion/contraction unit includes an elastic body and is configured to contract due to a restoring force of the elastic body.

12. The unmanned aerial vehicle according to claim 1, further comprising: a winding unit provided side by side with the expansion/contraction unit, wherein
the winding unit is configured to wind the expansion/contraction unit by a rotational operation to contract the expansion/contraction unit.

13. The unmanned aerial vehicle according to claim 1, further comprising: a pressure source configured to vary an internal pressure of the expansion/contraction unit, wherein
the expansion/contraction unit is configured to expand/contract due to an internal pressure variation.

14. The unmanned aerial vehicle according to claim 13, wherein the pressure source is configured to vary an internal air pressure of the expansion/contraction unit.

15. The unmanned aerial vehicle according to claim 13, wherein the pressure source is an aerosol container.

16. The unmanned aerial vehicle according to claim 1, wherein the contents are at least one of a liquid, a sol, or a gel.

17. A method of controlling an unmanned aerial vehicle, the method comprising:
guiding the unmanned aerial vehicle to a vicinity of a discharge target to which contents filled in a container of the unmanned aerial vehicle are discharged;
controlling expansion/contraction of an expansion/contraction unit provided to be expandable/contractible between a discharge port for discharging the contents and the container; and
discharging the contents to the discharge target.

18. The method according to claim 17, further comprising: controlling an angle of the discharge port with respect to the discharge target before the discharging the contents to the discharge target.

19. The method according to claim 17, further comprising:
moving the unmanned aerial vehicle with respect to the discharge target in a predetermined direction; and
controlling the expansion/contraction of the expansion/contraction unit according to an outer shape of the discharge target while moving the unmanned aerial vehicle.

20. The method according to claim 17, further comprising:
detecting an outer shape of the discharge target and a distance to the discharge target after the guiding and before the controlling the expansion/contraction; and
adjusting a position and an angle of the unmanned aerial vehicle with respect to the discharge target on a basis of a result of detection of the discharge target.

21. (canceled)
